(19) United States
(12) Patent Application Publication
(10) Pub. No.: US 2007/0067717 A1
(43) Pub. Date: Mar. 22, 2007

(54) Basic work processing system

(76) Inventors: Shigefumi Wada, Tokyo (JP); Shigeru Nakayama, Tokyo (JP); Tomohisa Takahashi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/560,530

(22) PCT Filed: Jun. 13, 2003
(86) PCT No.: PCT/JP03/07559

§ 371 Date: Jul. 10, 2006

(51) Int. Cl. G06F 17/00

(52) U.S. Cl. 715/526

(57) ABSTRACT

It is an object to provide a key task processing system which, when a computer terminal is caused to execute a key task processing, is capable of inputting data using input assistant on both a screen in window format and a screen in web format similarly to the conventional technique. The key task processing system includes: a key task processing database which stores data for executing a key task processing of a company; a key task processing means which executes the key task processing using the data in the key task processing database; a means for window format which transmits/receives the data to be used in the key task processing means via the network to/from the user terminal which accepts input of the key task processing in window format; and a means for web format which transmits/receives the data to be used in the key task processing means via the network to/from the user terminal which accepts input of the key task processing in web format.

### TECHNICAL FIELD

The present invention relates to a key task processing system that is capable of, when a key task processing is executed, executing the processing on both a screen in window format and a screen in web format similarly to a conventional system. More specifically, the invention relates to the key task processing system that changes display of input assisting function names related with actuation of programs (input assisting functions) for executing predetermined processings on the screens according to a screen which is displayed currently and a present position of a cursor on the screen to thereby realize also input assisting of input for users.

### BACKGROUND ART

In companies, in order to perform their tasks, companies use various key task processing systems (or programs). Examples of the key task processing systems (or programs) are the systems for finance and accounting, payroll calculation, sales management, purchase control, stock management, tax declaration, fixed asset management, cost management, client management, human resource management and electronic banking.

Such key task processing systems conventionally execute only a processing by means of a single system connected by intracompany LAN, and for example, a screen of a key task processing system in windows format is realized by using Windows which is an OS made by Microsoft Corporation (WINDOWS is a registered trademark of Microsoft Corporation, hereinafter).

In case of inputting into key task processing systems, since its input items are wide-ranging, some functions of the key task processing system are allocated to function keys in advance in order to assist the inputting, and when the function key is pressed down or a place on the screen corresponding to the function key is selected by a pointing device (for example, a mouse), the function related to the function key is executed in the key task processing system. Such an input assisting system is disclosed in Japanese Patent Laid-Open Publication No. 8-129471.

With the recent development of computer technologies, it is desired that a sales representative and the like of a company accesses the key task processing system via an internet at a place to which this sales representative goes and checks a stock status and balances his or her transportation expenses. Further, it is desired that an employee of a company can easily input various notifications and application forms such as attendance notification and procurement request slip via a network such as Internet regardless of whether he or she is inside or outside of the company premises.

On the other hand, web formats such as HTML and XML which do not depend on OS are present as one of tools to be used in a network. When, therefore, the conventional key task processing systems are made to be compatible with the web format and key task processing systems are realized by using web browsers as screens, users such as sales representative can execute the key task processings such as checking of stock status and balancing of transportation expenses at places to which the users such as sales representatives go. Since the key task processing systems are, however, used also within companies, the conventional key task processing systems cannot be used without any modification.

Further, in the case where the screens are realized by using web browsers, since they do not depend on OS, seamless key task processing systems can be constructed without being constrained by the computer environments of the users. But since the processing itself is, however, executed on each screen of the web browser displayed at a computer terminal of the user (hereinafter, user terminal), the user cannot use the above-mentioned input assisting system (for example, Japanese Patent Laid-Open Publication No. 8-129471).

That is to say, since data to be inputted into the key task processing systems are wide-ranging, as disclosed in Japanese Patent Laid-Open Publication No. 8-129471, not only the display of the function keys is switched per screen but also the function keys corresponding to positions where a cursor is present (namely, an area where a user is going to input) are displayed on an input area of one screen, the input can be further assisted. For example, on the screen of the key task processing system displayed in FIG. 4, when a cursor is present in a date input field, the function keys are made to correspond to the processing functions which are capable of being actuated at this place (input assisting function) as shown in FIG. 4, and when the cursor is present in a slip No. input field, the function keys are made to correspond to the processing functions which are capable of being actuated as shown in FIG. 7 so that various input assistings are enabled.

In the above-mentioned web format, however, since each processing is executed on each screen, even if updating of relation between the function keys and the processing functions capable of being actuated and their display at a user terminal are realized at each time, when the cursor in the input field displayed on the screen changes, the screen is frequently updated, leading to the disturbance of the input by the user, and results in a problem such that the above-mentioned input assisting system cannot be provided to the users in the case of the web format.

### DISCLOSURE OF THE INVENTION

The inventors of the present invention have enabled the use of both a conventional single processing system (for example, a key task processing system based on OS of a window format) and a key task processing system in a web format which does not depend on OS.

In case of a processing of the key task processing system, when a processing on a screen in window format and a processing on a screen in web format are appropriately used according to its applications, the convenience is improved.

The processing on the screen in window format is suitable for a task processing which needs to process a lot of data at a high speed. A journal slip input processing in a finance and accounting task, a sales slip input (order entry) processing in a sales management task, a stock control (order placement) form input processing in a purchase management task, a payroll calculation processing in a payroll calculation task, and the like are executed suitably on the screen in window format. Further, in these task processings, since a lot of data need to be processed at a high speed, specific people in charge mostly execute these task processings in specific places within a company. Further, since these task processings are executed while the people in charge are accessing data in plural tables and are referring to related data and are making calculations, these processings are stereoscopic three-dimensional processings which require input assisting functions.

The processing on the screen of the web format is suitable mainly for task processing which needs to process personal information of employees, an attendance notification input processing, a business traveling expense balancing statement input processing, a transportation expense account input processing, a procurement request slip input processing, and the like are executed suitably on the screen in web format. Since these data are input and processed anytime in any places by anybody of a company, they are processed suitably on the screen in web format. Further, since these task processings are executed mostly in a document format, they are sheet type two-dimensional processings which are executed on an input screen and which can be used like documents which are filled in by hand.

In the key task processing system of the present invention, because the processing on the screen in window format and the processing on the screen in web format are provided, the key task processings can be executed by one OS and one database, so that the key task processing systems which are conventionally operated under individual system environments can be executed in an integrative manner.

Further, in the key task processing system which allows the use of both the window format and the web format, when the screen is displayed at a user terminal on the screen in web format, programs by means of C# language, JAVA language and the like, which enable the updating of the relation between predetermined keys on a keyboard (in this specification, the predetermined keys are function keys, but any other keys may be used) and processing functions which are capable of being actuated and its display on the user terminal, are transmitted. As a result, frequent switching on the screen is eliminated, and the input assisting can be provided to the users. Such a key task processing system is invented.

Further, in package software such as the key task processing system, conventionally, since a table and rows of a database are prefixed and destination places where data are saved or back-up is stored are also predetermined, in the case where such places are added or changed, there arises a problem such that data in a table and rows where the addition or change is made are not saved and backed up. In the above-mentioned key task processing system, however, when the tables and the rows where the addition and change are made can be identified according to a rule which is predetermined for the names of the tables and rows, data can be saved or backed up in the tables and the rows which are added by the key task processing system. For example, the head of the name of the added table is set to start with “T”, and the head of the name of the added row is set to start with “C”. When data are saved or backed up, the table and the row whose names start with “T” and “C” are automatically determined as that to be saved, so that data can be saved or backed up.

The present invention is a key task processing system that is capable of transmitting/receiving data to/from a user terminal owned by a user via a network, comprising: a key task processing database that stores data for executing key task processings of a company therein; a key task processing means that executes the key task process using the data in the key task processing database; a means for window format that transmits/receives the data to be used in the key task processing means via the network to/from the user terminal which accepts input of the key task processing in window format; and a means for web format that transmits/receives the data to be used in the key task processing means via the network to/from the user terminal which accepts input of the key task processing in web format, wherein the means for window format and the means for web format execute the processing using the key task processing database on one OS for operating the key task processing system.

According to the present invention, the key task processing system, which cannot execute the processing only on a single processor conventionally, can be displayed at the user terminal in web format which does not depend on OS. For this reason, the key task processing system can be executed in various processors at the user terminal.

Further, the present invention is the key task processing system in which the user terminal that displays a screen of the key task processing in window format includes: a data converting function that converts the data in the key task processing means into data of data format processable in window format; an input assisting function that is used on a screen on which the data are displayed; and a display function that combines the converted data with the extracted input assisting function so as to display them on the screen in window format, the means for web format transmits contents of the screen in web format in document format to the user terminal that accepts the input of the key task processing in web format.

Furthermore, in the key task processing system, when the data to be used in the key task processing means are transmitted in web format to the user terminal that accepts the input of the key task processing in web format, the means for web format extracts the input assisting function on the screen on which the data are displayed and combines the extracted input assisting function with the data so as to transmit contents of the screen in web format.

In the key task processing system, the means for web format includes: a data converting means that converts the data in the key task processing means into data of data format processable in web format; an input assisting means that extracts the input assisting functions to be used on the screen on which the data are displayed; and a web screen creating means that combines the data converted by the data converting means with the extracted input assisting functions so as to create the screen in web format.

In the key task processing system, the input assisting functions are related with function keys on a keyboard of the user terminal, when the screen is changed or a cursor position is changed on the screen, changes the corresponding relationship between the input assisting functions and the function keys, and changes display of the names of the input assisting functions on the screen according to the change of the corresponding relationship.

In addition, in the key task processing system, the input assisting functions receive pressing-down of the function key, or receives selection of the name of the input assisting function on the screen using a pointing device, so as to execute the related input assisting function at the user terminal.

According to these invention, the input assisting functions can be used on the screens in window format conventionally, and also on the screen in web format. Particularly on the screen in web format, when the input assisting functions to be used thereon are combined with the contents of the screen so as to be transmitted from the key task processing system to the user terminal, for example, unnecessary change of the screen does not have to be made in the case where the cursor position is changed, and only the display of the names of the input assisting functions is simply changed. As a result, the inputting in web format by the user is not disturbed.

In the above inventions, the key task processing system is configured so that when a new table or row is added, the key task processing means adds any one of predetermined character, number and symbol to the head of the table name or the row name and stores it in the key task processing database, and when data are saved in the key task processing database, it saves a table or a row predetermined by the key task processing means and the table or the row having the predetermined character, number or symbol at its head.

Conventionally, in the key task processing system which is sold as a package software, a table or a row in which the data are saved are prefixed. According to the present invention, when any one of predetermined character, number and symbol is added to the new added table or row name, the added new table and row can be recognized when the key task processing system executes the saving processing. As a result, omission at the time of data saving does not occur.

In the present invention, in the case where the row is added in the above manner, in order to save it in the database, a type of data, a length of data and the like are required to save the data as a row name. For this reason, in the key task processing system, when the user stores the new added row in the key task processing database, the key task processing means stores data about the new added row in the key task processing database according to functions previously owned by the key task processing means which executes a writing/saving processing and are set by accepting setting of a name, a data type and a data length of the added row as arguments of the functions.

According to the present invention, even the row added by the user can be easily written and saved in the key task processing database.

Further, in the key task processing system, the user terminal that accepts the input of the key task processing in window format includes: an additional menu definition file that defines contents of additional menu items to be displayed on a menu bar provided to the screen frame in window format or a menu area provided into the screen in window format; and an additional menu display/calling execution file that reads a menu title or a menu button, which are added to the display of the menu items on the menu bar or the menu area, and an additional menu group, which is displayed on a drop-down menu or an additional menu list when the menu title or the menu button is selected, from the additional menu definition file, displays them on the menu bar or on the screen in window format, and reads to execute a related execution file in the additional menu when the additional menu is selected.

Conventionally, only the prefixed menu bar or the menu area to be displayed on the screen in window format can be displayed, but according to the present invention, a menu name can be added into the menu bar or the menu area freely by the user even on the user terminal to be used in the key task processing system of the present invention.

### BRIEF DESCRIPTION OF THE DRAWINGS

FIG. 1 is a system configuration diagram illustrating one example of a system configuration according to the present invention;

FIG. 2 is a flowchart illustrating one example of a flow of a process according to the present invention;

FIG. 3 is a conceptual diagram illustrating function keys on a keyboard;

FIG. 4 is a diagram illustrating one example of a journalizing process screen in the case where a key task processing means is a finance and accounting program;

FIG. 5 is a diagram illustrating one example of a compound trial balance screen;

FIG. 6 is a diagram illustrating one example showing a screen in the case where a cursor is present in a date input field on the journalizing process screen and a relation between the function keys and input assisting functions in this case;

FIG. 7 is a diagram illustrating one example of a screen in the case where the cursor is present in a slip No. input field on the journalizing process screen and the relation between the function keys and the input assisting functions in this case;

FIG. 8 is a diagram illustrating one example of a screen in the case where the cursor is present in a division code input field on the journalizing process screen and the relation between the function keys and the input assisting functions in this case;

FIG. 9 is a diagram illustrating one example of a screen in the case where the cursor is present in a combined account subject code input field on the journalizing process screen and the relation between the function keys and the input assisting functions in this case;

FIG. 10 is a diagram illustrating one example of a screen in the case where the cursor is present in an assist subject code input field on the journalizing process screen and the relation between the function keys and the input assisting functions in this case;

FIG. 11 is a diagram illustrating one example of a screen in the case where the cursor is present in a sum input field on the journalizing process screen and the relation between the function keys and the input assisting functions in this case;

FIG. 12 is a diagram illustrating one example of a screen in the case where the cursor is present in an abstract code input field on the journalizing process screen and the relation between the function keys and the input assisting functions in this case;

FIG. 13 is a diagram illustrating one example of a relation table between the function keys and the input assisting functions on the journalizing process screen;

FIG. 14 a diagram illustrating one example of an attendance notification input screen in the case where a screen of web format is a document format;

FIG. 15 is a diagram illustrating one example of a business traveling expense balancing statement input screen in the case where the screen of a web format is a document format;

FIG. 16 is a diagram illustrating one example of a transportation expense account input screen in the case where the screen of web format is a document format;

FIG. 17 is a diagram illustrating one example of a procurement request slip input screen in the case where the screen of web format is a document format;

FIG. 18 is a diagram illustrating addition of a new menu to a menu bar on the screen of window format;

FIG. 19 is a diagram illustrating an additional menu definition file;

FIG. 20 is a conceptual diagram in the case where a row of E-mail address is added to a client information table;

FIG. 21 is a diagram illustrating a state before the new menu is added to a menu area on the screen of windows format;

FIG. 22 is a diagram illustrating a state after the new menu is added to the menu area on the screen of window format;

FIG. 23 is a system configuration diagram illustrating one example of a system configuration in the case of a user terminal having additional functions of a new menu for the menu bar and the menu area;

FIG. 24 is a diagram illustrating one example of the attendance notification input screen in the case where the screen of web format has the input assisting functions;

FIG. 25 is a diagram illustrating one example of the business traveling expense balancing statement input screen in the case where the screen of web format has the input assisting functions;

FIG. 26 is a diagram illustrating one example of functions of a writing means;

FIG. 27 is a diagram illustrating arguments of the functions of the writing means;

FIG. 28 is a diagram illustrating one example of data of arguments; and

FIG. 29 is a diagram illustrating one example of data of arguments.

### BRIEF DESCRIPTION OF REFERENCE NUMERALS

1: key task processing system, 2: user terminal (window client), 3: user terminal (web client), 4: network, 5: key task processing means, 6: means for window format, 7: means for web format, 8: data converting means, 9: input assisting means, 10: web screen creating, 11: key task processing database, 20: keyboard, 21: function key, 30a: additional menu definition file, 30b: additional menu display/calling execution file, 31: menu bar, 32: menu title, 33: additional menu, 34: drop-down menu, 35: menu button, 36: additional menu list, 37: menu area, 38: display of input assisting function names related to the function keys

### BEST MODE FOR CARRYING OUT THE INVENTION

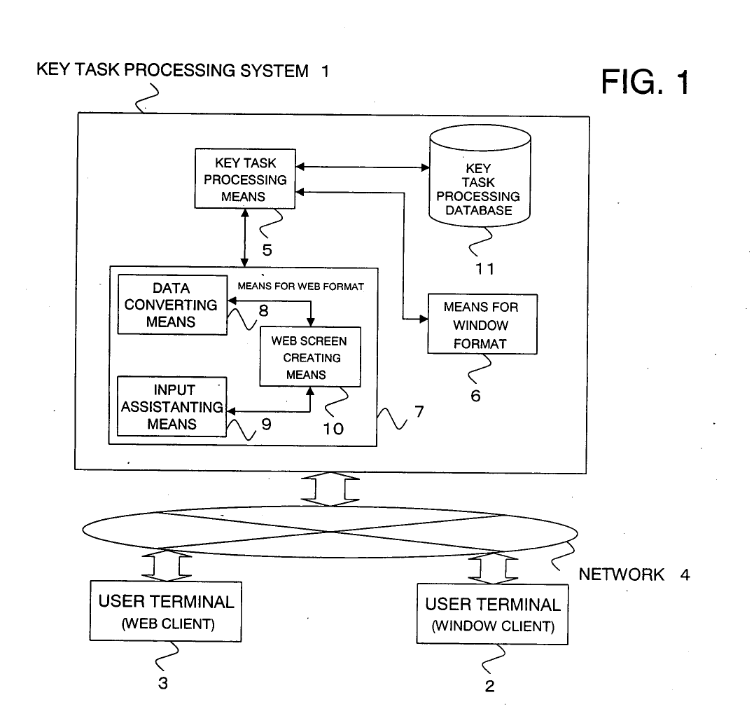

On example of a system configuration of a key task processing system according to the present invention is shown in the system configuration diagram of FIG. 1. A key task processing system 1 can transmit/receive data to/from a user terminal (web client) 3 of a user who utilizes the key task processing system 1 in web format and a user terminal (window client) 2 of a user who utilizes the key task processing system 1 in window format via a network 4. The network 4 may be any one of an open network such as internet, a closed network such as LAN and an intranet formed by combining them regardless of wired or wireless.

The key task processing system 1 is a computer terminal which accepts input of a key task processing from the user terminal used by the user via the network 4, and it has a key task processing means 5, means for a window format 6, means for a web format 7 and a key task processing data base 11. The key task processing system is operated by one OS, and the respective means and the database which are used there executes the processings on this one OS.

The key task processing means 5 is a program (function) for executing key task processings of a company on a computer terminal (including a server), and its examples are a finance and accounting program, a payroll calculation program, a sales management program, a purchase control program, a stock control program, a tax declaration program, a fixed asset control program, a cost management program, a client management program, a human resource management program, and an electronic banking program.

The key task processing database 11 is a database that stores data corresponding to various programs which are used when the key task processing means 5 executes the key task processing therein.

Examples of the database are a finance and accounting database in which finance and accounting data of a company are stored correspondingly to the finance and accounting program, a payroll calculation database in which payroll calculation data of a company are stored correspondingly to the payroll calculation program, a sales management database in which sales management data of a company are stored correspondingly to the sales management program, a purchase control database in which purchase control data of a company are stored correspondingly to the purchase control program, a stock control program in which stock control data of a company are stored correspondingly to the stock control program, a tax declaration database in which tax declaration data of a company are stored correspondingly to the tax declaration program, a fixed asset control database in which fixed asset control data of a company are stored correspondingly to the fixed asset control program, a cost management database in which cost management data of a company are stored correspondingly to the cost management program, a client management database in which client management data of a company are stored correspondingly to the client management program, a human resource management database in which human resource management data of a company are stored correspondingly to the human resource management program, and an electronic banking database in which electronic banking data are stored correspondingly to the electronic banking program.

The window format means 6 is a means that, when the key task processings are executed at the user terminal (window client) 2, transmits data at the time of executing the key task processings to the user terminal 2 via the network 4 or receives data at the time of executing the key task processings from the user terminal 2 via the network 4.

As mentioned hereinafter, the screen of the key task processing system 1 is displayed in a window format on a display section (display device) of the user terminal (window client) 2, but it is a means for transmitting/receiving data to be displayed on the screen between the key task processing means 5 and the user terminal (window client) 2.

The means for web format 7 is a means that, when the key task processings are executed at the user terminal (web client) 3, creates a screen at the time of executing the key task processings in web format on the user terminal 3, transmits the created screen in web format via the network 4 (at this time, when data are previously attached to the screen, the data format of the key task processing means 5 is converted into the data format of web format), or receives data input into the screen in web format via the network 4 so as to convert them into data in a format to be capable of being processed by the key task processing means 5. Further, the web format means 7 is a means that transmits/receives data to be displayed on the display section (display device) of the user terminal (web client) 3 between the key task processing means 5 and the user terminal 3. The web format means 7 has a data converting means 8, an input assisting means 9 and a web screen creating means 10.

The data converting means 8 is a means, when the screen is transmitted in web format from the key task processing means 5 to the user terminal (web client) 3, converts the data format which is capable of being processed by the key task processing means 5 into the data format which is capable of being processed in web format or converts the data format which is capable of being processed in web format into the data format which is capable of being processed by the key task processing means 5.

In the case where, for example, the key task processing means 5 is set so as to be capable of being mainly processed on Windows made by Microsoft Corporation as OS, since the user terminal (window client) 2 is actuated by Windows made by Microsoft Corporation as OS, the means for window format 6 executes a processing in a format processable on Windows, such as Win 32 application or Windows Form. Since the key task processing means 5, however, cannot process data in web format, the data converting means converts the data format into such as HTML format or XML format so as to adjust the data thereby to have web format. In another manner, the data converting means converts the data format such as HTML format or XML format into the data format of the key task processing system 1 so as to execute the processing.

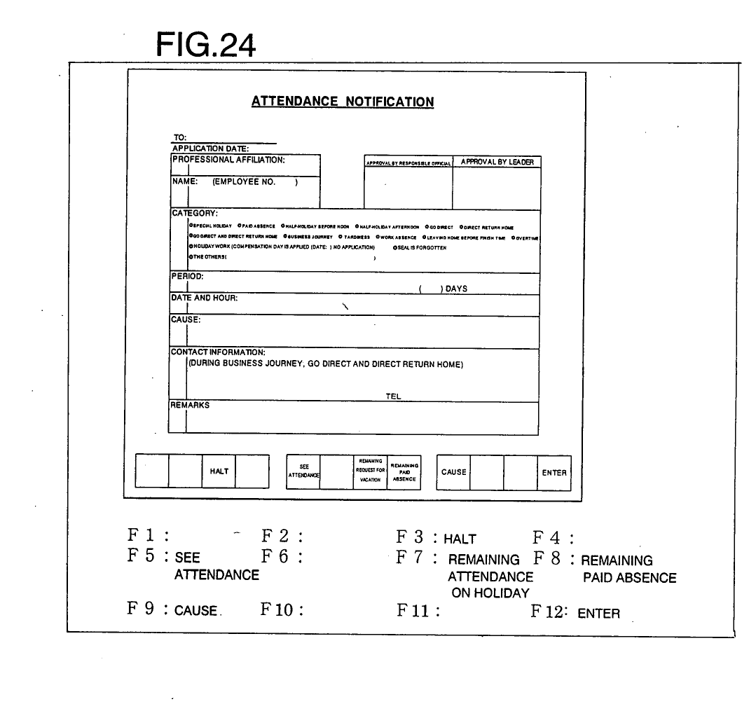

The input assisting means 9 is a means, when the user terminal (web client) 3 uses the input assisting functions so as to transmit the screen and display the screen in web format thereon, extracts the input assisting functions to be used on the screen (for example, a component which is realized by JAVA script or C# language and runs on an NET platform). In the case, for example, where the screen in web format is an attendance notification input screen (FIG. 24), since the assisting functions which can be used on the screen are, as shown in FIG. 24, “halt”, “see attendance”, “remaining holiday attendance”, “remaining paid absence”, “cause” and “enter”, the input assisting means 9 is a means that extracts the respective input assisting functions.

The web screen creating means 10 is a means that combines the data converted by the data converting means 8 with the input assisting functions extracted by the input assisting means 9 and sets them in a predetermined position of the screen so as to create the screen in web format.

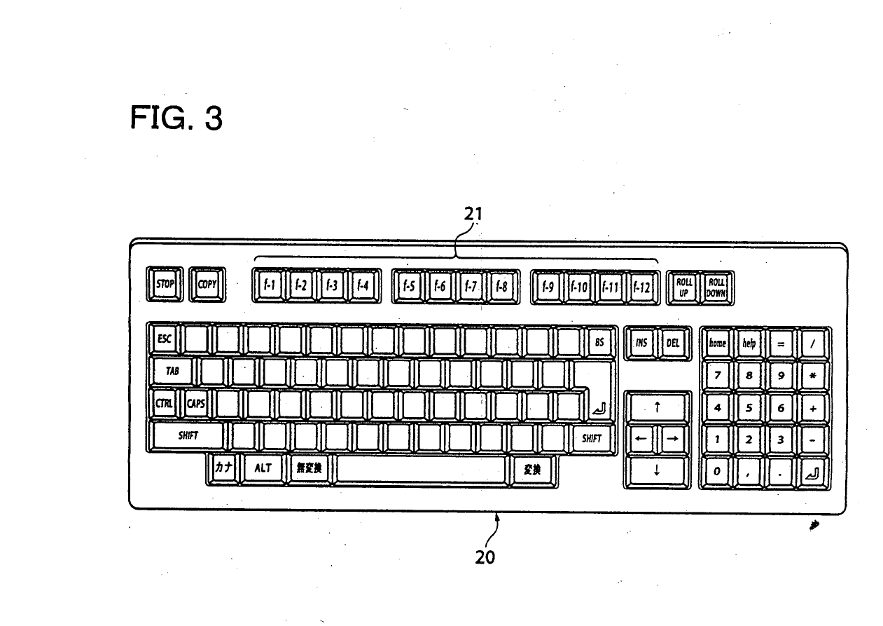

On the screen in web format created in such a manner, similarly to the screen in window format, the names of the input assisting function are displayed on a lower part of the screen, and these names are related with function keys 21 on the keyboard 20 of the user terminal (web client) 3 (this specification, as mentioned above, explains the case where predetermined keys on the keyboard 20 are the function keys 21, but any other keys such as ten keys may be used). For this reason, when a user presses down, for example, “F1” or selects a button on which the name of the input assisting function related with “F1” is displayed using a pointing device on the screen, the input assisting function related with the “F1” set according to the screen is actuated so as to be executed. The function keys 21 on the keyboard 20 are shown in FIG. 3.

As mentioned later, when the input assisting functions are not used on the screen in web format, it is a means for creating a web screen by using the data converted by the data converting means 8 as a document format and for transmitting the web screen to the user terminal (web client) 3.

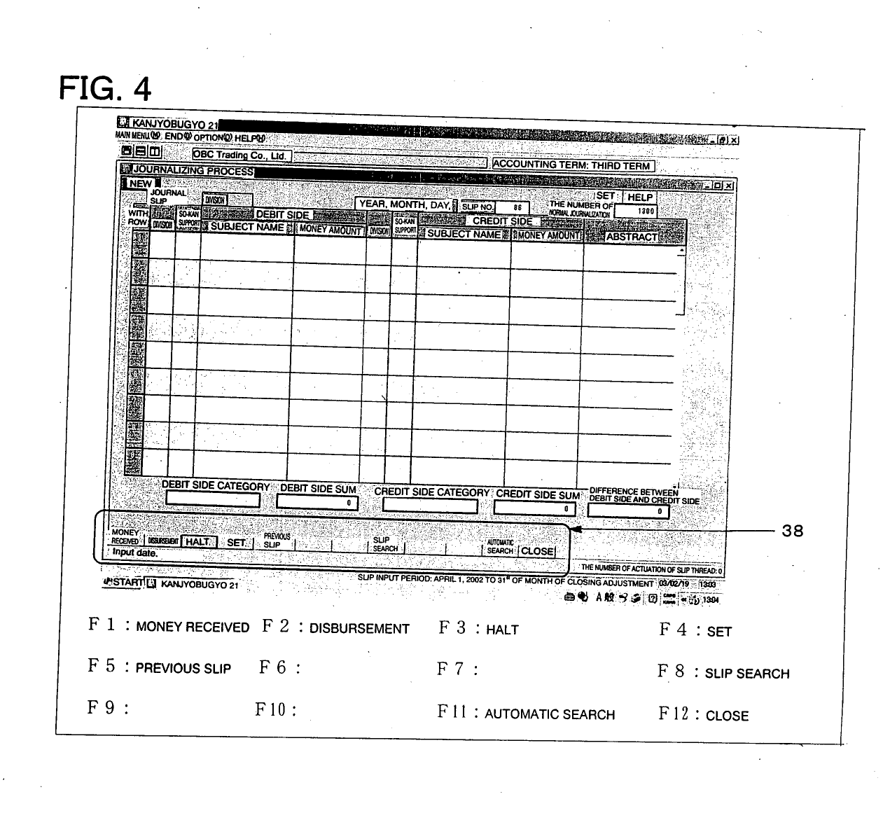

The user terminal (window client) 2 is a computer terminal which is used by a user and which operates the key task processing system 1, and displays the screen of the key task processing system 1 in window format thereon. The user terminal (window client) 2 previously has software on the client side having a display function of a screen (not shown), an input assisting function (not shown) and a data converting function (not shown) correspondingly to the key task processing system 1. The display function of the screen is a function that displays the key task processing system 1 in window format, and the input assisting function is a function that changes a corresponding relationship between the function keys 21 and the previously related input assisting functions and changes the display of the names of the input assisting functions by changing the screen in window format or changing the cursor position. The display of the names of the input assisting functions related with the function keys 21 is shown in 38 of FIG. 4.

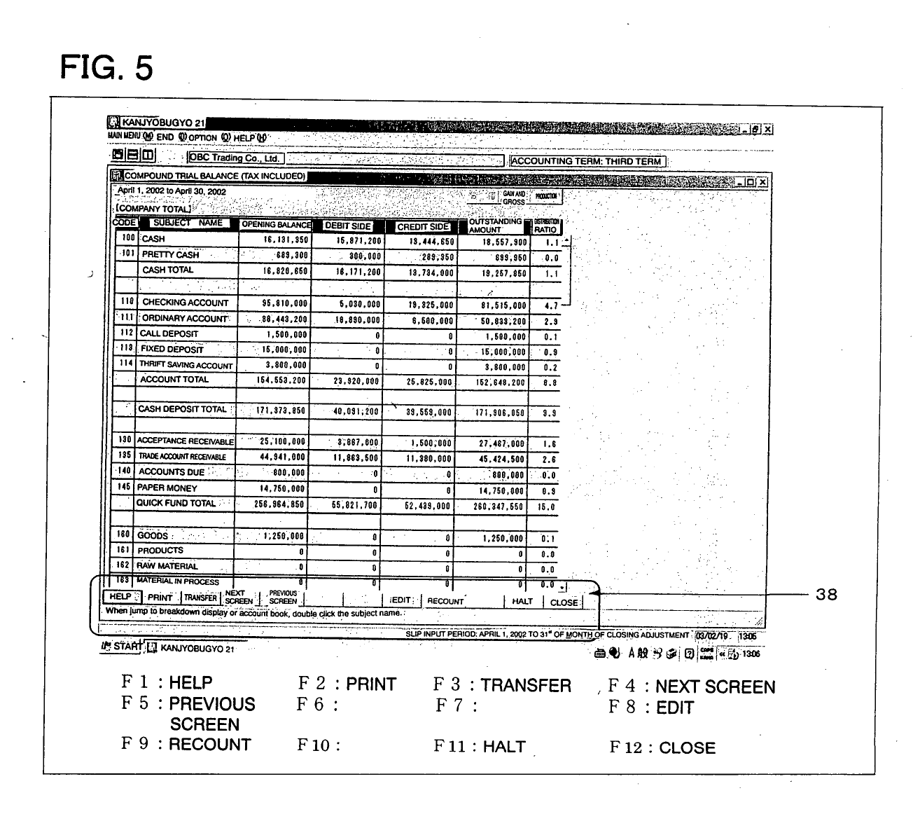

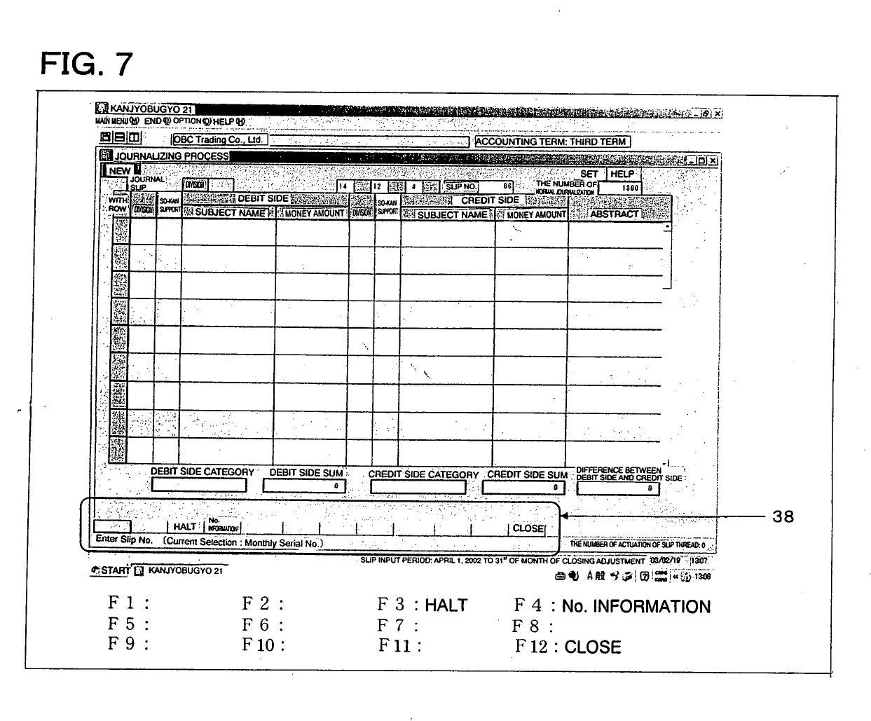

In one example of the screen shown in FIG. 4, the names of the input assisting functions are displayed on a lower part of the screen in window format, and when the cursor position is in a date input field, the function key F1 is related with “money received”, the function key F2 is related with “disbursement of cash”, the function key F3 is related with “halt”, the function key F4 is related with “set”, the function key F5 is related with “previous slip”, the function key F8 is related with “slip search”, the function key F11 is related with “automatic search”, and the function key F12 is related with “close”. When this screen is changed into a different screen shown in FIG. 5 or the cursor position is changed on even the same screen shown in FIG. 7 (in this case, slip No. input field), the corresponding relationship between the function keys 21 and the input assisting functions is changed and accordingly the display of the names of the input assisting functions is changed. When, therefore, the screen is changed into the screen of FIG. 5, the corresponding relationship between the function keys 21 and the input assisting functions and display are changed in such a manner that the function key F1 is related with “help”, the function key F2 is related with “print”, the function key F3 is related with “transfer”, the function key F4 is related with “next screen”, the function key F5 is related with “previous screen”, the function key F8 is related with “edit”, the function key F9 is related with “recount”, the function key F11 is related with “halt”, and the function key F12 is related with “close”. When the cursor position is changed as shown in FIG. 7, the corresponding relationship between the function keys 21 and the input assisting functions and the display of the names of the input assisting functions are changed in such a manner that the function key F3 is related with “halt”, the function key F4 is related with “No information”, and the function key F12 is related with “close”.

On such a screen, when one of the function keys 21 is pressed down or a button on which the name of the input assisting function is displayed on the screen is selected by using the pointing device, the input assisting function is actuated.

The data converting function is a means that converts a data format when the data format of the data displayed in window format is different from the data format used at the time of executing a processing in the key task processing system 1. For example, it converts the data format of the key task processing system 1 into the data format in window format and display the data, or it converts the data format of window format into the data format of the key task processing system 1 so that the processing is executed.

The user terminal (web client) 3 is a computer terminal owned by a user who operates the key task processing system 1, and it displays and operates the screen of the key task processing system 1 in web format. Further, it is a matter of course that the user terminal 3 previously has a web browser which is compatible with the web format to be used in the key task processing system 1.

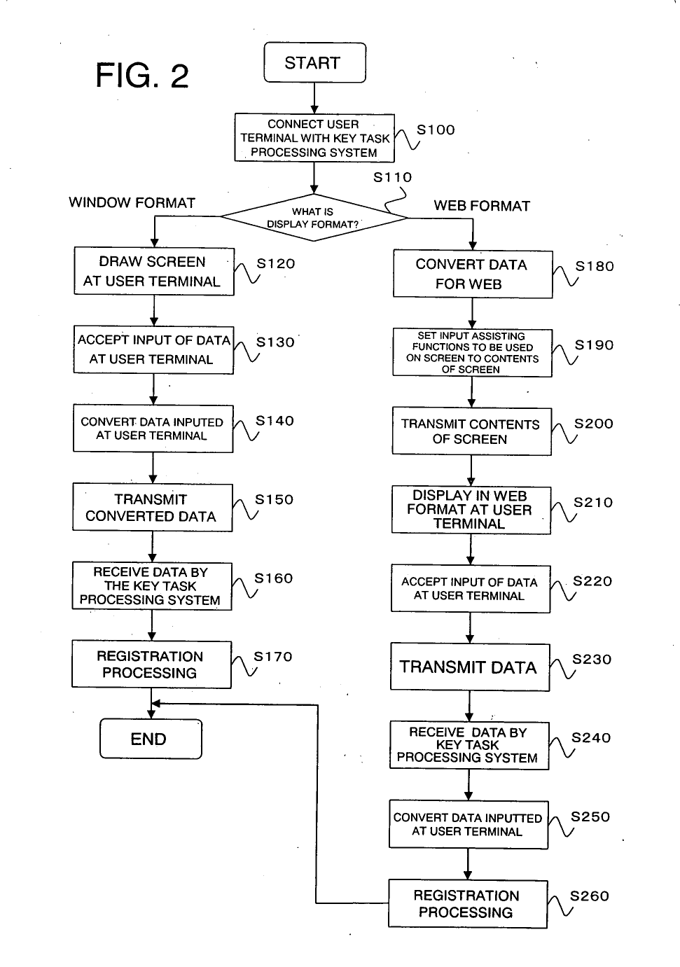

One example of a flow of the process in the key task processing system 1 according to the present invention is explained in detail below with reference to a flowchart of FIG. 2.

In the case where the user desires to use the key task processing system 1 in window format or web format from the user terminal, the user accesses the key task processing system 1 using the user terminal (window client) 2 or the user terminal (web client) 3 which is owned by the user via the network 4, and a connection is established so that data can be transmitted/received between the user terminal 2 or the user terminal 3 and the key task processing system 1 (S100).

The key task processing system 1 determines, after accepting the connection, which format the user uses for executing a processing or receives the information regarding in which format the user terminal executes the processing (S110). This determination may be made by, for example, a user ID, or depending on whether the access is an access from inside of the company or an access from the outside of the company. In the case where the identification is made by the user ID, when a user A has an ID of window format, a user B has an ID of web format and a user C has an ID of IDs of both formats, the key task processing system 1 previously has differentiation (for example, it is stored in the database) so as to make the determination using the ID inputted by the user. In the case where the differentiation is made by an accessing place, when the user terminal the access from which is accepted has a local IP address, it may execute the process in window format, and when the user terminal has an address other than the local IP address, it may execute the process in web format. When the determination is automatically made in such a manner, user's input work can be reduced.

A process in the case where the display format is window format at step S110, namely, the user terminal is the user terminal (window client) 2 is explained below.

Since the user terminal (window client) 2 has the software on the client side which is compatible with the key task processing system 1, namely, the display function (not shown) of the screen, the input assisting function (not shown), and the data converting function (not shown), the user performs a predetermined operation to actuate the software on the client side of the key task processing system 1, and the screen is drawn at the user terminal (S120).

One example of the screen displayed at the user terminal at this time is shown in FIG. 4. FIG. 4 shows a data input screen (journalizing processing screen) for the journalizing processing in the case where the key task processing means 5 is the finance and accounting program.

At the time of drawing at S120, the input assisting functions related with the journalizing processing screen are extracted from the software on the client side, the names of the input assisting functions are also displayed on the lower part 38 of the screen. The display position is preferably the lower part of the screen, but another position is also preferable.

In the example of FIG. 4, since the cursor position is present in the date input field, as for the input assisting functions, the function key F1 is related with “money received”, the function key F2 is related with “disbursement of cash”, the function key F3 is related with “halt”, the function key F4 is related with “set”, the function key F5 is related with “previous slip”, the function key F8 is related with “slip search”, the function key F11 is related with “automatic search”, and the function key F12 is related with “close”. The names of the input assisting functions are displayed on the journalizing processing screen 38 so as to be related with the function keys 21.

The user carries out the input on the journalizing processing screen (S130), but at the time of the input, when pressing-down of the function key 21 of the user terminal (window client) 2 or the selection of the name of the input assisting function on the screen by means of the point device such as the mouse is received, the input assisting function of the software on the client side receives this, so that the corresponding input assisting function is executed. For example, when the function key F1 is pressed down, the input assisting function “money received” related with the function key F1 is executed.

Further, when the user displays a compound trial balance shown in FIG. 5 is displayed from journalizing processing screen, at the time of displaying the screen, the software on the client side extracts the input assisting function related with the cursor position, and displays the name of the input assisting function on the screen so that the name is related with the function key 21. That is to say, on the journalizing processing screen, the corresponding relationship between the function keys 21 and the input assisting functions is updated, and the updated names of the input assisting functions are displayed.

The corresponding relationships of the input assisting functions are updated in such a manner that the function key F1 is related with “help”, the function key F2 is related with “print”, the function key F3 is related with “transfer”, the function key F4 is related with “next screen”, the function key F5 is related with “previous screen”, the function key F8 is related with “edit”, the function key F9 is related with “recount”, the function key F11 is related with “halt”, and the function key F12 is related with “close”, so that the display of the names of the input assisting functions is changed.

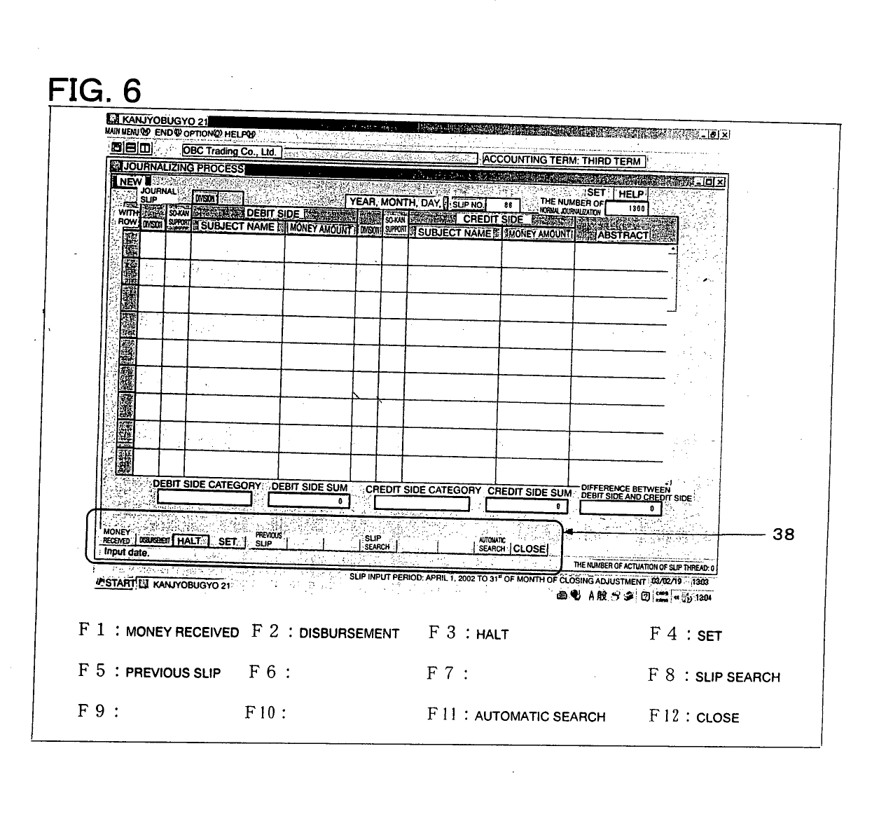

Similarly in the case where the user displays the journalizing processing screen in FIG. 4 (FIG. 6 shows the similar screen), when the cursor position is changed, for example, when the date input field is changed into the slip No. input field, the software on the client side receives the change so as to update the corresponding relationship between the function keys 21 and the input assisting functions and the display of the names of the input assisting functions into the input assisting functions related with the slip No. input field on the journalizing processing screen. That is to say, the corresponding relationships of the input assisting functions are updated in such a manner that the function key F3 is related with “halt”, the function key F4 is related with “No information” and the function key F12 is related with “close”, so that the display of the names of the input assisting functions is changed.

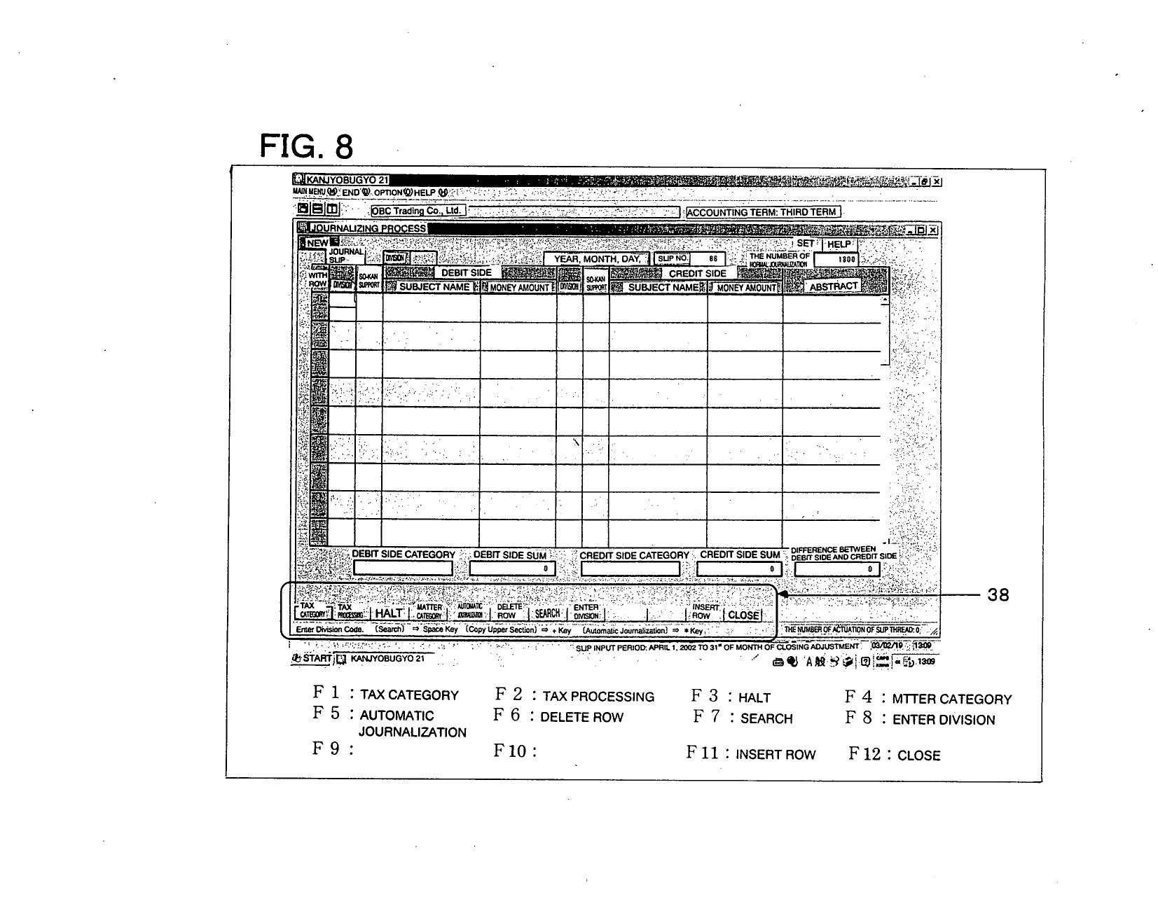

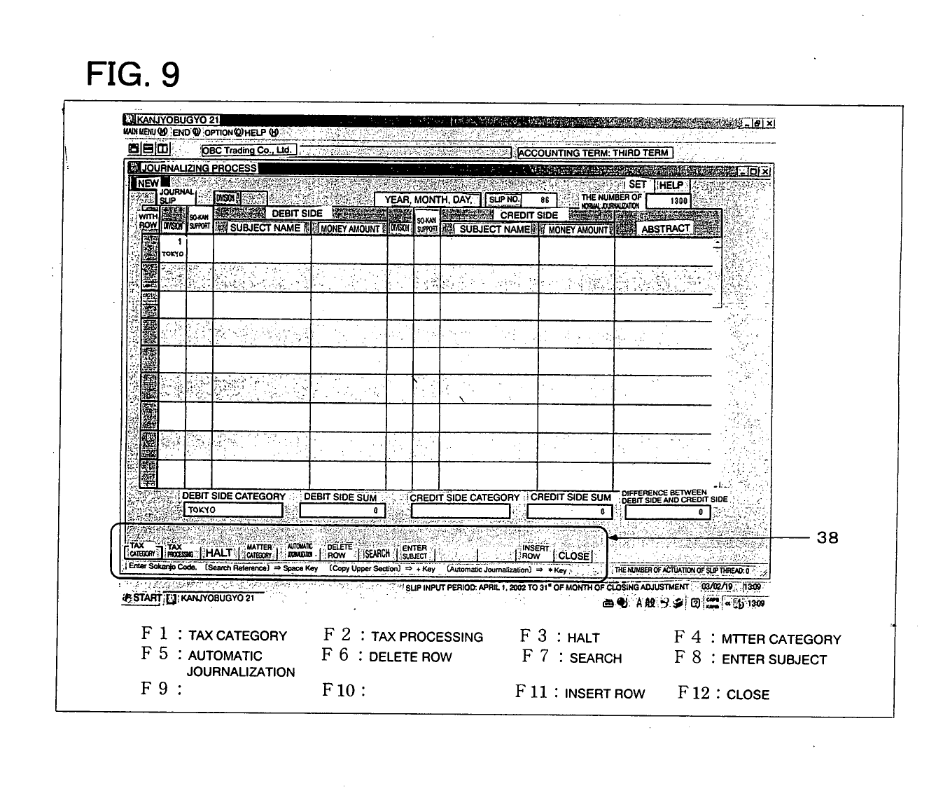

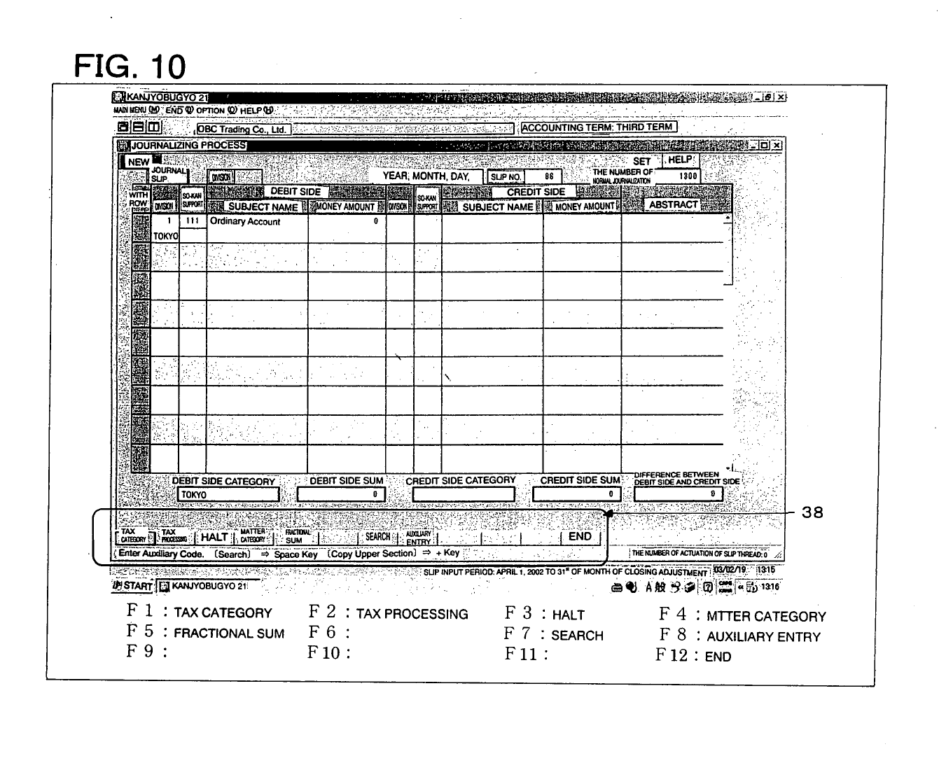

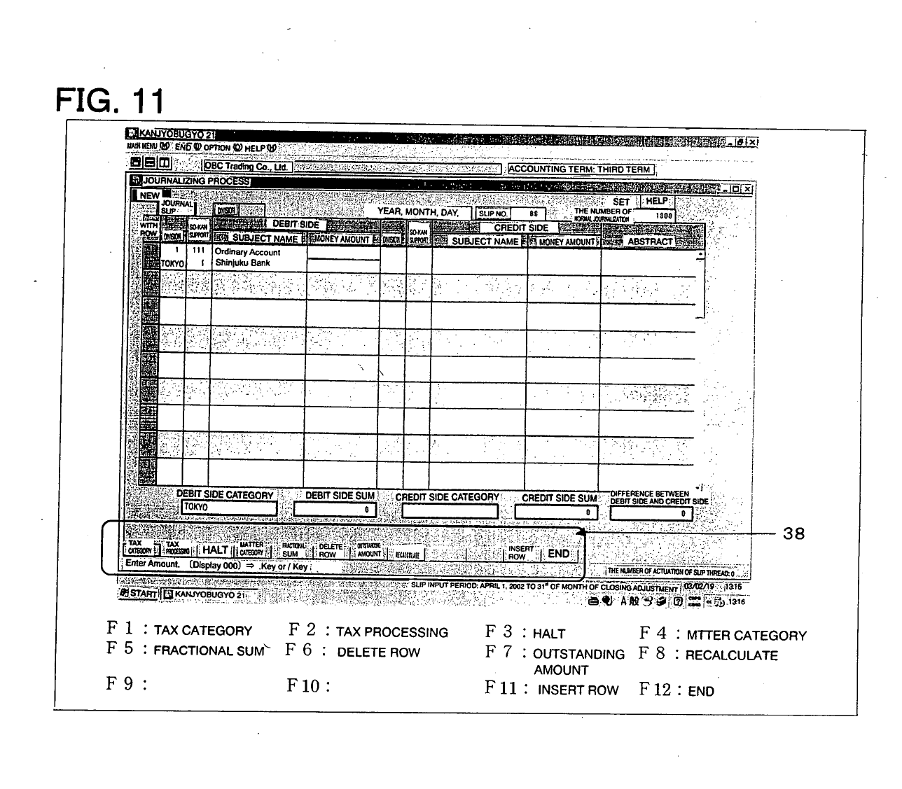

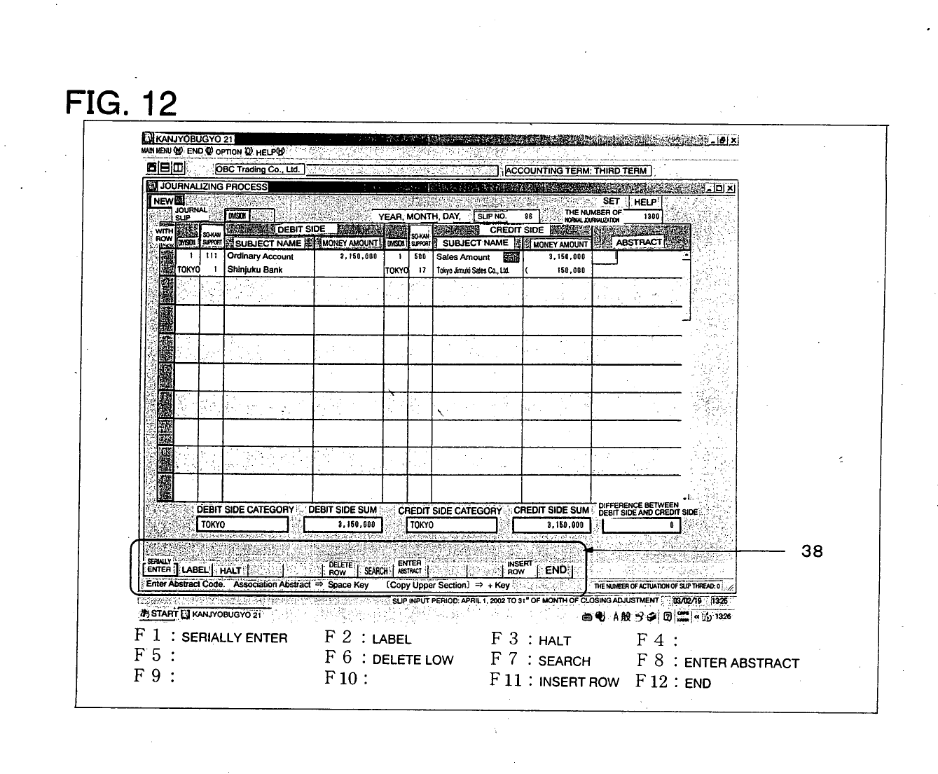

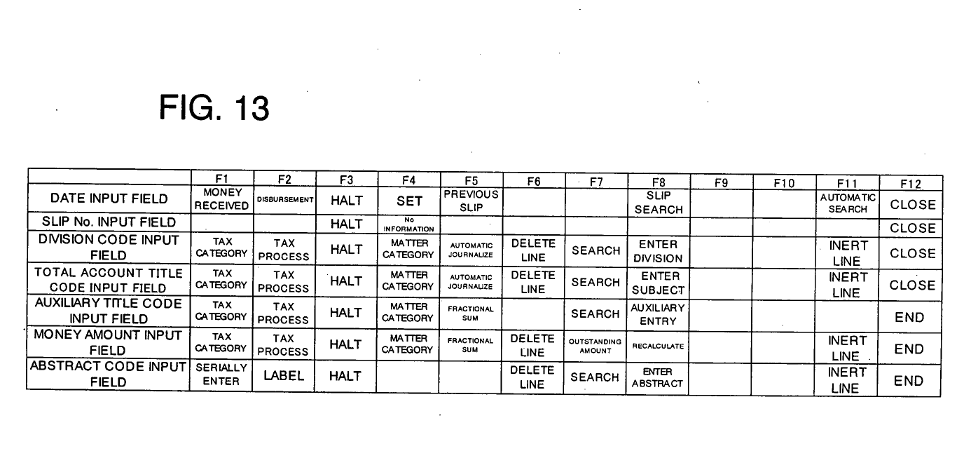

FIGS. 7 to 12 show examples of the screens on which the corresponding relationships between the function keys 21 and the input assisting functions in the case where the cursor position is changed on the journalizing processing screen. FIG. 7 illustrates the case where the cursor position is in the slip No. input field, FIG. 8 illustrates the case where the cursor position in a division code input field, FIG. 9 illustrates the case where the cursor position is in a combined account subject code input field, FIG. 10 illustrates the case where the cursor position is in an assist subject code input field, FIG. 11 illustrates the case where the cursor position is in a sum input field, and FIG. 12 illustrates the case where the cursor position is in an abstract code input field. FIG. 13 illustrates a list of the relationships between the function keys 21 and the input assisting functions on the journalizing processing screen.

When such a series of inputs are carried out by the user terminal (window client) 2 and the data are transmitted to the key task processing system 1, the data converting function of the software on the client side converts the data format displayed in window format into the data format used in the key task processing system 1 (S140). When the data format used for window format is identical to the data format used in the key task processing system 1, this conversion is not necessary.

After the conversion, the converted data (when the conversion is unnecessary, inputted data) are transmitted from the user terminal (window client) 2 via the network 4 to the key task processing system 1 (S150).

The window format means 6 of the key task processing system 1 receives data from the user terminal (window client) 2 via the network 4 (S160), and transmits them to the key task processing means 5. The key task processing means 5 enters the received data into the key task processing database 11 and executes the key task processing (S170).

The process in the case where the display format is the web format, namely, the user terminal is the user terminal (web client) 3 at S110 is explained below.

When the user terminal (web client) 3 transmits data for executing predetermined input of the key task processing to the key task processing system 1, the key task processing system 1 receives the data, and the key task processing means 5 extracts necessary data from the key task processing database 11 and also transmits them to the means for web format 7.

The data converting means 8 of the means for web format 7 converts the data received from the key task processing means 5 into data format which is processable in web format (S180).

Further, in the means for web format 7, the input assisting means 9 extracts the input assisting functions related with the screen to be displayed at the user terminal (web client) 3 based on the data received from the key task processing means 5. The input assisting functions are preferably described in format which is compatible with the web format. The input assisting functions to be extracted here are components which run on an NET platform where the input assisting functions which are possibly used on the screen are realized by JAVA script, C# language or the like.

The web screen creating means 10 combines the data converted into web format by the data converting means 8 with the input assisting functions extracted by the input assisting means 9 so as to thereby create the screen of web format (S190). That is to say, the input assisting functions to be used on the screen are combined with the contents on the screen (converted data), and the function names are set to be displayed on predetermined position of the screen (preferably, the lower portion of the screen). The web screen creating means 10 transmits the screen created in such a manner to the user client (web client) 3 via the network 4 (S200).

The user terminal (web client) 3 receives the screen, and displays it at the user terminal (web client) 3 using a predetermined web browser (S210). The case where screen to be displayed in such a manner is an attendance notification input screen is shown in FIG. 24. In FIG. 24, data which are used in the key task processing means 5 (including input format and the like) are displayed on from an upper portion to a center portion of the screen, and predetermined input assisting functions to be used on the screen are displayed on the lower portion. The function key F3 is related with “halt”, the function key F5 is related with “see attendance”, the function key F7 is related with “remaining holiday attendance”, the function key F8 is related with “remaining paid absence”, the function key F9 is related with “cause” and the function key F12 is related with “enter”, so that the names of the input assisting functions are displayed. The user inputs necessary data into the screen for web format displayed in such a manner (S220).

When the user presses down the function key 21 at the user terminal (web client) 3 or selects the function key 21 using the pointing device such as the mouse, the related input assisting function is executed. For example, when the function key F12 is pressed down, since the data entry is going to be carried out, the input assisting function that enters data is actuated so as to thereby transmit the data input into the attendance notification input screen from the user terminal (web client) 3 via the network 4 to the key task processing system 1. The web format means 7 receives the transmitted data, and converts the web format of the data into a data format for the key task processing system 1, and the key task processing means 5 enters the data.

Further, when the cursor position is changed, for example, the cursor position shifts to an employee number field, the input assisting function receives the movement of the cursor position, and the input assisting functions which are related with the employee number field are searched so that the names of the related input assisting functions are displayed on the lower portion of the screen.

In the case where the cursor position is changed, when the input assisting functions are also changed similarly to the conventional technique, the entire screen in web format constitutes one processing, so that the entire screen should be switched. As mentioned above, however, the input assisting functions which are used on that screen are combined with the screen at the time of firstly displaying the screen and the set is transmitted to the user terminal (web client) 3, and the relation between the input assisting functions and the function keys 21 on the screen in web format is changed and the display of the names of the input assisting functions is changed as the need arises. As a result, the user does not have to access the key task processing system 1 and to change the screen every time when the cursor position is changed. That is to say, on the same screen, only the display of the names of the input assisting functions combined with that screen is changed, i.e., the lower portion of the screen is changed in FIG. 24, and thus this does not disturb the viewability for the user.

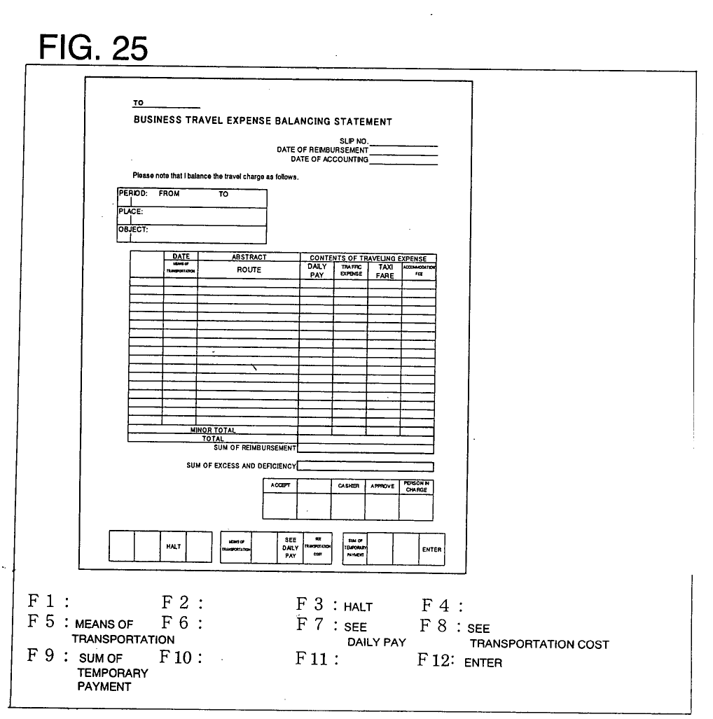

Further, in the case where the user switches the screen, for example, the attendance notification input screen of FIG. 24 is changed to a business traveling expense balancing statement input screen of FIG. 25, an acquisition request of the business traveling expense balancing statement input screen is transmitted from the user terminal (web client) 3 via the network 4, and the web format means 7 of the key task processing system 1 receives the acquisition request. When the key task processing means 5 receives the acquisition request, it extracts necessary data from the key task processing database 11 similarly to the above-mentioned case, so as to transmit the data to the means for web format 7. The means for web format 7 converts the format of the data into the web format, the input assisting means 9 extracts the input assisting functions to be used on the screen (business traveling expense balancing statement input screen), and the web screen creating means 10 combines the converted data with the input assisting functions extracted by the input assisting means 9 on one screen, and the combined data are transmitted to the user terminal (web client) 3 via the network 4. In the case where the change of the screen is requested in such a manner, the input assisting functions which are used on the screen are combined with the screen so as to be transmitted, and thus, the unnecessary switching of the entire screen can be eliminated.

FIG. 25 illustrates one example of the traveling expense balancing statement input screen on which the corresponding relationship between the function keys 21 and the input assisting functions are displayed on the screen in web format.

When a series of inputs are carried out at the user terminal (web client) 3 in such a manner and the data are transmitted to the key task processing system 1 via the network 4 (S230), the means for web format 7 of the key task processing system 1 receives the data (S240).

After the means for web format 7 receives the data, the data converting means 8 converts the web format into the data format to be used in the key task processing system 1 (S250), and the key task processing means 5 enters the data into the key task processing database 11 so as to execute the key task processing (S260).

In this specification, it is preferable that the input processing function which is displayed in window format is described by programming languages such as C# language, and the input processing function which is displayed in web format is described by a language which is processable in a web browser, such as C# language and JAVA language.

Further, it is preferable that when the screen in web format is transmitted, in the means for web format 7, after the data converting means 8 converts the data of the key task processing means 5, the web screen creating means 10 creates the web screen in a document format for displaying input items, input positions and the like similarly to the document related with the screen in web format (namely, a normal document is directly replaced by the screen in web format), and the user terminal (web client) 3 displays the web screen.

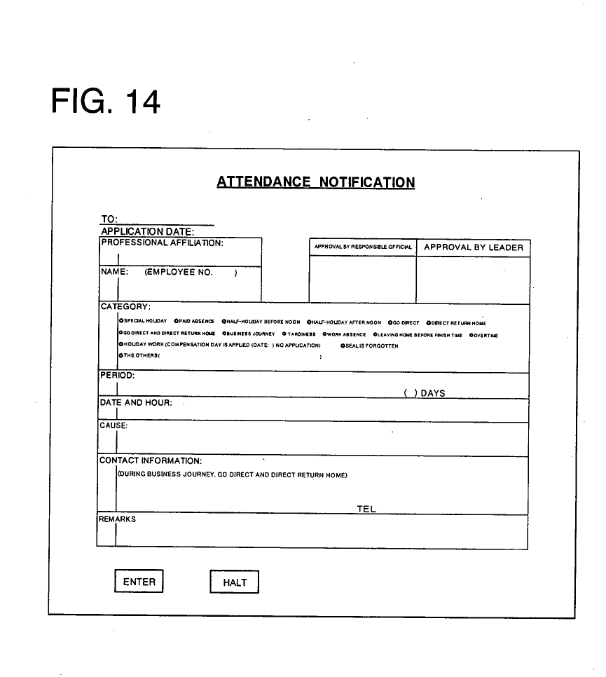

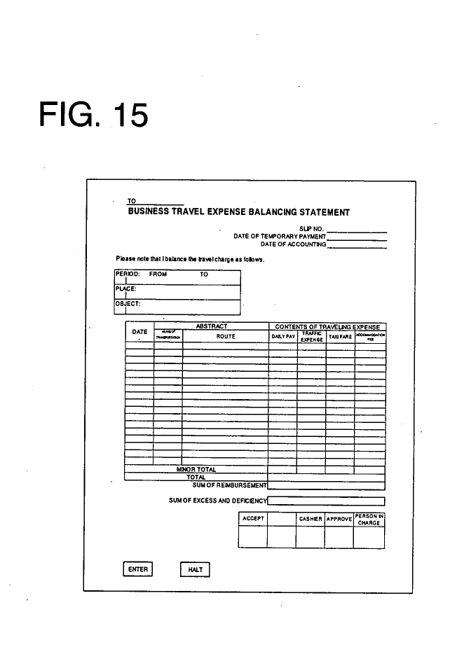

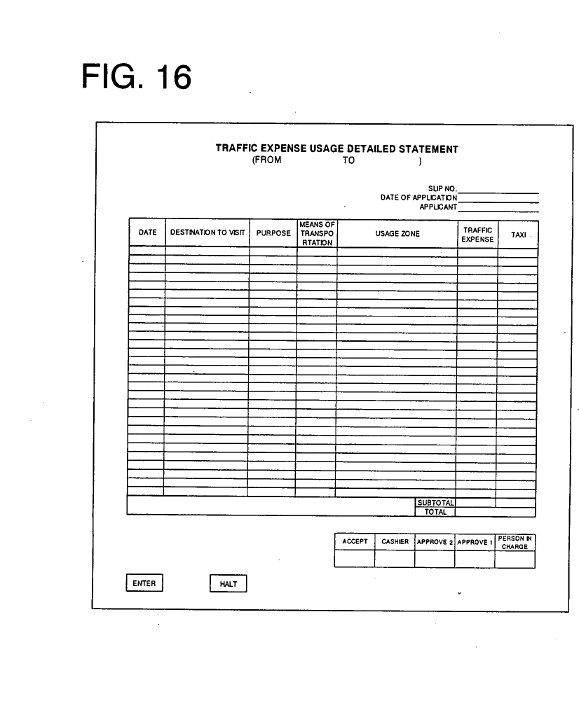

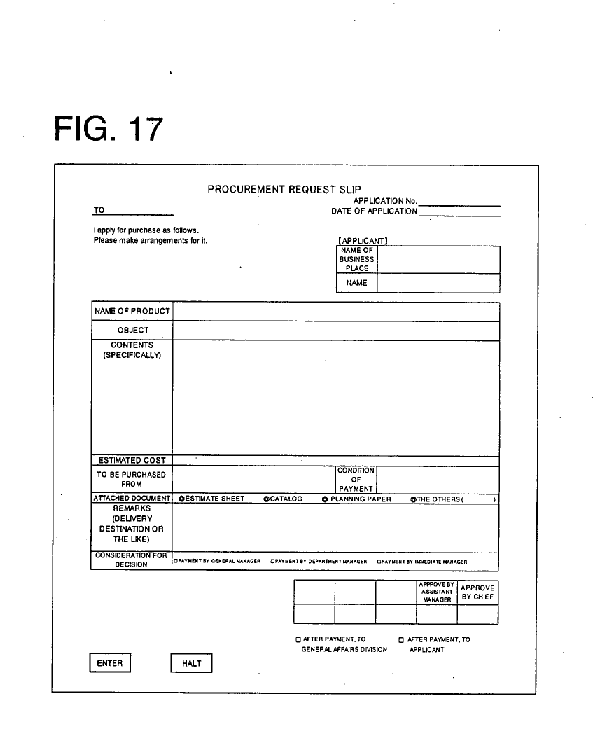

Examples of the input screen of the document format are the attendance notification input screen (see FIG. 14 (in the case where the input assisting functions are not used), and FIG. 24 (in the case where the input assisting functions are used)), the traveling expense balancing statement input screen (see FIG. 15 (in the case where the input assisting functions are not used), and FIG. 25 (in the case where the input assisting functions are used)), a transportation expense account input screen (see FIG. 16), a procurement request slip input screen (see FIG. 17), a business transaction daily report input screen, a qualification statement input screen, a family status report input screen, a name card request format input screen, a fixed asset disposal application form input screen, a family-care leave and short-time work for family-care application form input screen, a child-bearing leave application form input screen, a child-care leave application form input screen, administrative leave request input screen, a condolence memo input screen, a wedding memo input screen, a relocation application form input screen, an input screen of an application form for salaried worker dependent exemption and the like (relocation), and an input screen of a return form for insurance premium deduction. Examples of a reference screen of document format are a pay statement reference screen, a sales spreadsheet reference screen, and a stock list reference screen.

In the process of the key task processing system 1, when the process on the screen in window format and the process on the screen in web format are used according to its applications, convenience is heightened.

The process on the screen in window format is suitable for a task process for processing a lot of data at a high speed, and the journal slip input processing in the finance and accounting task, the sales (order entry) slip input processing in the sales management task, the stock control (order) form in the purchase control task, the payroll calculation processing in the payroll calculating task and the like are suitable for the processing on the screen in window format. Further, since these task processings are required to process a lot of data at a high speed, specific people in charge mostly execute the task processings in specific places of a company. Since these task processings are executed while the people in charge are accessing the data in a plurality of tables and referring to the data, and making calculations, the task processings become stereoscopic three-dimensional processings which require the input assisting functions.

The processing on the screen in web format is suitable mainly for the task processings which need to process employees' personal information, and the attendance notification input processing, the business traveling expense balancing statement input processing, the transportation expense account input processing, the procurement request slip input processing, and the like are suitable for the processing on the screen in web format. Since these data are inputted and processed anytime by any employees in any places, the data are suitably processed on the screen in web format. Further, since these task processings are mostly in document format, they become sheet-type two-dimensional processings for processing data on the screen of document format which can be used like documents which are filled in by hand. In the case where, therefore, the screen is displayed at the user terminal (web client) 3, the web screen creating means 10 creates the screen of document format, and the screen is displayed at the user terminal (web client) 3. As a result, even if the user has not obtained a mastery of a computer operation, the user can carry out the inputting freely.

In such a web format, the input screen of document format is displayed and the key task processings are executed (sheet-type two dimensional processing), and in a window format, while using the input assisting functions, the user accesses the data in a plurality of tables in the key task processing database 11, so that the key task processings can be executed (stereoscopic three-dimensional processing).

As mentioned above, in the key task processing system 1 of the present invention, the window format means 6 and the means for web format 7 are provided thereto, so that the key task processings can be executed by using one OS and one database, and thus the key task processing system which is operated under separate system environments can be operated in an integrative manner. As the OS of the key task processing system 1 at this time, Windows Server 2003 made by Microsoft Corporation can be used.

Further, in the case where data are inputted into the screen in web format from the user terminal (web client) 3, the means for web format 7 which receives the data posts the execution of the inputs to a computer terminal of a superior of the user who carried out the inputting (a database which stores personnel relations such as organizational affiliation therein is provided to the key task processing system 1, the database is referred to, and the inputs may be posted to the user's superior via E-mail or the like). When the superior refers to the screen on which the inputtings are carried out and executes a publicly-known payment processing, the key task processing means 5 again receives the execution of the payment processing by the superior, and the execution of the payment processing is automatically stored in the key task processing database 11.

In addition to the key task processing system 1, when the data are stored in the database, the key task processing means 5 adds predetermined characters, numbers, symbols and the like to an added new table or its rows. That is to say, as disclosed in Japanese Patent Laid-Open Publication No. 2000-207477, “T” is added to the head of the table name added by the user in the key task processing, or “C” is added to the head of the added table name so that the table name and the row name are set. In another manner, the key task processing means 5 automatically adds predetermined characters, numbers, symbols and the like such as “T” or “C” to the head of the added table name and the added row name received from the user terminal (window client) 2 or the user terminal (web client) 3. As a result, when the key task processing means 5 saves data, not only predetermined table and row but also the table and the row to which the identification names such as “T” and “C” are added are set to be saved, so that the added table and row can be saved with certainty.

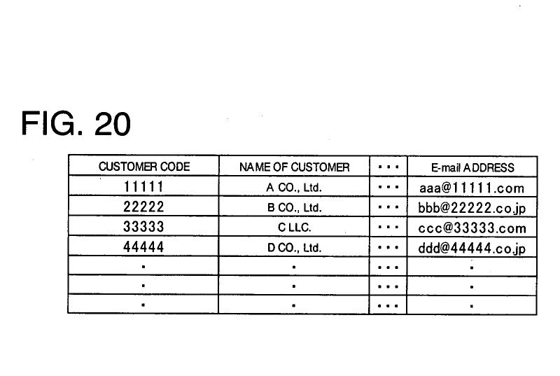

In one example, the key task processing program to be used in the key task processing means 5 is the client management program, and the client management program which is provided firstly as a package to the client information table of the key task processing database 11 (client management database) (namely, the client information table to be used in the client management database just after the system is introduced) does not have a function for entering E-mail addresses. Therefore, since the row into which E-mail addresses are entered is not present, the user further adds the row for E-mail addresses. FIG. 20 is a conceptual diagram of the client information table in the case where such a function for entering E-mail addresses is added to the client management program, and the respective rows for client code, client name and E-mail address are provided to the client information table.

In the client information table after the row for E-mail address is added, the client code and the client name are contents entered in the client information table, and the user inputs an E-mail address. Since the E-mail address inputted by the user using the user terminal (window client) 2 or the user terminal (web client) 3 is a row which is newly added, a variable named by, for example, C_mailaddress is set based on the above-mentioned rule so as to be transmitted to the key task processing system 1 via the network 4. When the key task processing means 5 of the key task processing system 1 receives the variable, the received E-mail address is stored in C_mailaddress row which is newly added to the client information table. When the client information table is saved, not only the row which is originally present but also data about the name of C_mailaddress row whose head is “C”, namely, data about the E-mail address can be saved.

The key task processing means 5 writes the data about the added row and table into the key task processing database 11, and should execute the saving processing. As to software which is sold as the conventional key task processing program, since its processing contents are in a predetermined range, a row and a table cannot be added, and also the data about the added new row and table cannot be written into the key task processing database 11 and the saving processing cannot be executed. This is because in order to execute the writing and saving processings, the row name, a type of data to be inputted into the row (an integer type (int type), a floating point type (float type), a character string type (char type) and the like), and a length of data to be inputted into the row (bite count) are not determined, a space for writing cannot be secured in the key task processing database 11. In the present invention, therefore, the key task processing means 5 writes the added row and table into the key task processing database 11 so as to be capable of being saved.

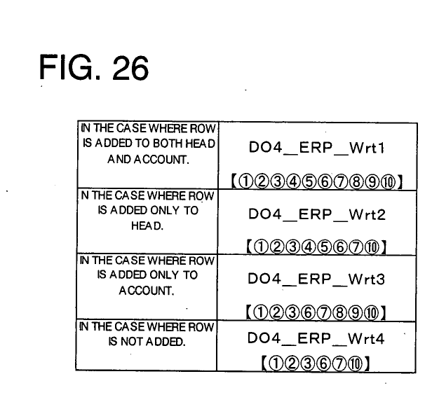

The key task processing means 5 has a writing means (not shown) that writes data about the added row and table into the key task processing database 11 and executes the saving processing. The writing means is composed of programs to be executed in the key task processing system, preferably a plurality of functions. One example of the functions of the writing means is shown in FIG. 26.

In the case where the key task processing means 5 is the sales management system (program), the functions of the writing means shown in FIG. 26 are functions to be written into the table of the sales slip (hereinafter, the sales slip writing function). The sales slip table is one of the tables in the key task processing database 11, and it is composed of a slip head portion table and a slip account portion table. The slip head portion table is composed of data, which are other than a sales account in the sales slip and include slip category (category of charge sale and cash sale), sales date, purchase date, slip No., valued customer code, valued customer name, code of person in charge, name of person in charge, abstract code, abstract name and the like in the sales slip.

The slip account table is composed of data relating to sales account of sales category (category of sales, returned articles, discount and the like), goods code, goods name, consumption tax category, category of net of tax and gross of tax, quantity decimal digit, unit cost decimal digit, warehouse number, order number, the number of arrived goods, the number of boxes, quantity, unit, sales unit cost, unit products cost, sales cost, consumption tax, and simultaneous processing flag (flag for executing a simultaneous incoming merchandise processing or a simultaneous production processing).

The sales slip writing functions shown in FIG. 26 are composed of four kinds of functions according to forms of rows to be added. The first one is DO4_ERP_Wrt1 for writing data about the sales slip (namely, slip head portion data and slip account data) into the slip head portion table and the slip account table in the key task processing database 11 in the case where the row is added to both the slip head portion table and the slip account table. The second one is DO4_ERP_Wrt2 for writing data about the slip check (namely, the slip head portion data and the slip account portion data) in the case where the row is added to the slip head portion table into the slip head portion table and the slip account portion table in the key task processing database 11. The third one is DO4_ERP_Wrt3 for writing data about the sales slip (namely, the slip head portion data and the slip account portion data) in the case where the row is added to the check statement portion table into the slip head portion table and the slip account portion table in the key task processing database 11, and the fourth one is O4_ERP_Wrt4 for writing data about the sales slip (namely, the slip head portion data and the slip account portion data) in the case where the row is not added into either of the slip head portion table and the slip account portion table in the key task processing database 11.

In the case, therefore, where any row is not added to the sale slip table in the key task processing database 11, the function DO4_ERP_Wrt4 is used to execute the writing processing on the sales slip table, and in the case where the row is added to any one of the tables, suitable any one of the three functions DO4_ERP_Wrt1, DO4_ERP_Wrt2 and DO4_ERP_Wrt3 is used to execute the writing processing on the key task processing database 11.

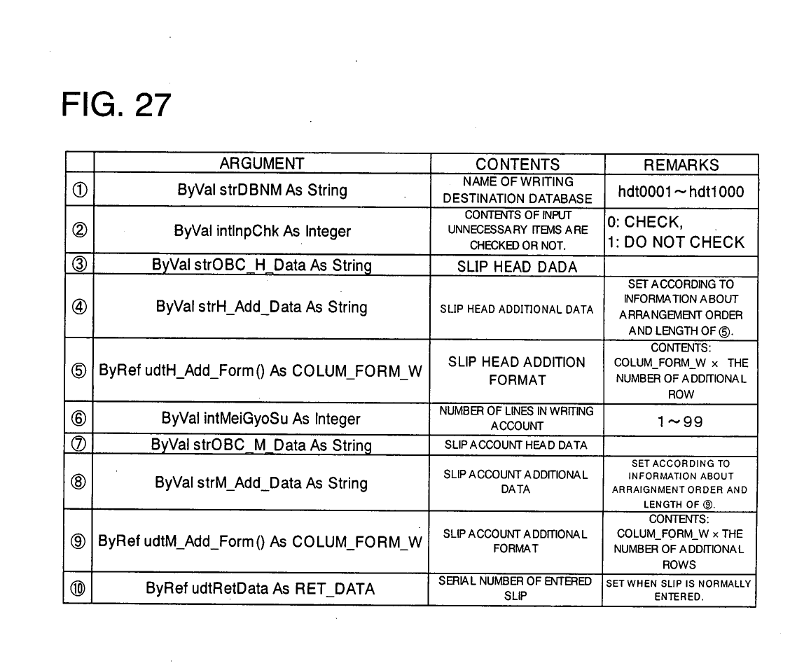

These four functions each have an argument, and the arguments are shown in FIG. 27. \textcircled{1} to \textcircled{10} described below the functions in FIG. 26 show the arguments which are used in the functions in the arguments of FIG. 27.

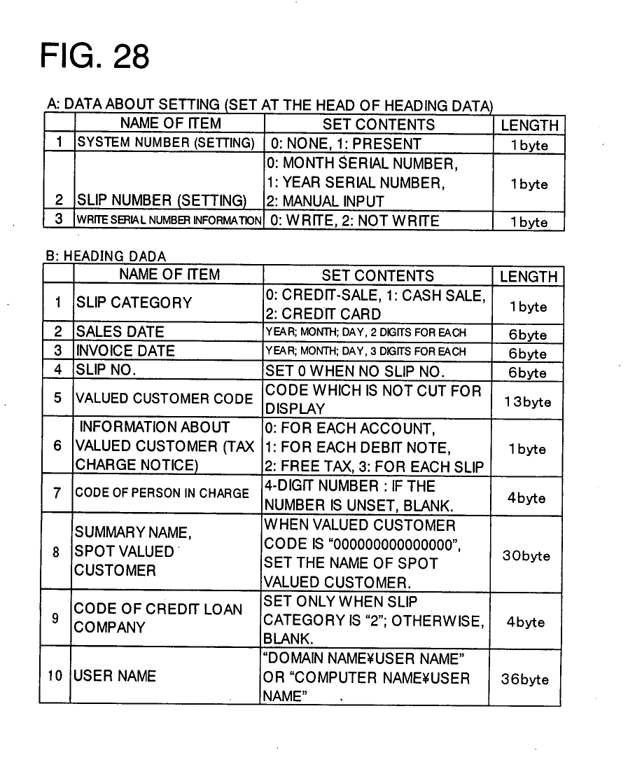

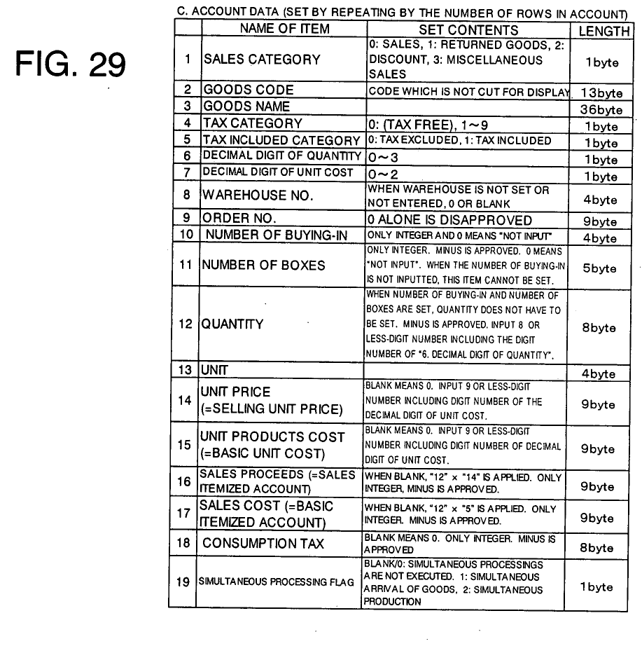

The argument \textcircled{1} (strDBNM) is an argument that defines on which database (or table) in the key task processing database 11 the writing processing is executed. The argument \textcircled{2} (intlnpChk) is an argument that defines whether or not the contents of items which do not have to be inputted are checked. The argument \textcircled{3} is an argument of data in the row which is originally set in the slip head portion table. In the above examples, the slip category (category of charge sale and cash sale), the sales date, the invoice date, slip No., valued customer code, code of person in charge, and abstract code are data about the arguments. FIG. 28 shows examples of data about the arguments. The argument \textcircled{4} (strH_Add_Data) is an argument of the data in the row added at user's own wish in the slip head portion table. The argument \textcircled{5} (udtH_Add_Form( )) defines the name of added row, the type of variable, and the length of variable in the row added by the argument \textcircled{4}. The definition of the added row defined by the argument \textcircled{5} is referred to by the argument \textcircled{4}, so that arbitrary row name, type and length set by the user can be written and saved in the key task processing database 11. The argument \textcircled{6} (intMeigyosu) defines the number of data lines in the sales slip account portion table which are written. The argument \textcircled{7} (strOBC_M_Data) is an argument of data in the originally set row in the slip account portion table. In the above examples, the argument data are the sales category (category of sales, returned goods, discount and the like), the goods code, the goods name, the consumption tax category, the category of net of tax and gross of tax, the quantity decimal digit, the unit cost decimal digit, the warehouse number, the order number, the number of arrived goods, the number of boxes, the quantity, the unit, the sales unit cost, the unit products cost, the sales cost, the consumption tax, and the simultaneous processing flag (flag for executing a simultaneous incoming merchandise processing or a simultaneous production processing). FIG. 29 shows an example of the argument data. The argument \textcircled{8} (strM_Add_Data) is an argument of data in the row added at user's own wish in the slip account portion table. The argument \textcircled{9} (udtM_Add_Form( )) defines the added row name, variable type, and variable length in the row added by the argument \textcircled{8}. The definition of the added row defined by the argument \textcircled{9} is referred to by the argument \textcircled{8}, so that arbitrary row name, type length set by the user can be written and saved in the key task processing database 11. The argument \textcircled{10} (udtRetData) is an argument for storing a serial number of the slip entered in the sales slip table of the key task processing database 11.

A flow of the process for processing the writing functions of the key task processing means 5 in the case where a row is added to the slip head portion table is explained below.

For example, in the case where an orderer specifies direct delivery destination of goods in the sales slip processing and desires to reflect the destination in the sales slip, the user adds a new address of the direct delivery destination as a row to the sales slip table.

Since the address of the direct delivery destination is not data about the sales account, this is a processing to the slip head portion table. Since the input field for the address of the direct delivery destination is not present as a row in the slip head portion table, the user adds the input field as a new row to the slip head portion table.

The process for adding a new row to the slip head portion table is executed by using the above-mentioned embodiment, and for example, its row name is set to C_DirectDeliveryAddress.

Since the row name is just added to the slip head portion table, the user uses the writing function of the key task processing means 5 so as to be capable of writing the data about the added row into the key task processing database 11.

Since this process adds a new row name to the check head portion table, DO4_ERP_Wrt2 of the writing functions shown in FIG. 26 is used. Since the arguments which are referred to by the functions are the arguments \textcircled{1} to \textcircled{7} and \textcircled{10}, the respective arguments are set.

The argument \textcircled{1} is the name of a database in which the address of added direct delivery destination is written and saved, namely, the name of the key task processing database 11 here as well as the data about the row previously prepared as the ales slip table. The argument \textcircled{2} is for whether or not the contents of the items which do not have to be inputted are checked, namely, 0 means “check” and 1 means “do not check”. As for the argument \textcircled{3}, the data which are originally prepared as the slip head portion table may be used, and thus it is not particularly changed and is directly used. As for the argument \textcircled{4}, the data about the row added to the slip head portion table can be used as the argument, and thus the address of the direct delivery destination becomes the argument. Since the argument \textcircled{5} defines the row name, the type of data and the length of variable added by the argument \textcircled{4}, the added row name is C_DirectDeliveryAddress, the type of data is char type (since the address of the direct delivery destination is character string, it is char type, but another data type may be used. As to the respective data types, since alphanumerics or the like related with the data types are set in such a manner that int type is set to 1, float type is set to 2, char type is set to 3 and long type is set to 4, the related alphanumerics are set. Here, since the data type is char type, 3 is set). As the length of variable, 80 byte (this is the byte number which is necessary for inputting the address of the direct delivery destination (since they are expressed by two-byte characters, two bytes are necessary for inputting one character)) is set. As the argument \textcircled{6}, the number of specific lines in the slip account portion table such as 10 (10 lines) is suitably set. Since as for the argument \textcircled{7}, data which are prepared as the slip account portion table may be used, the data are not particularly changed and are directly used as the argument. Since the argument \textcircled{10} is a serial number, when a new sales slip is entered as the slip head portion table, the key task processing means 5 sets the serial number as needed, and thus it does not have to be set at first.

The new writing function DO4_ERP_Wrt2 is provided to the key task processing means 5, so that the data about the row added in the above embodiment can be written and saved in the key task processing database 11.

As mentioned above, a new row can be added to the slip account portion table. Such a case meets a need such that the user is in the apparel business, and creates a sales sheet according to colors of shipped clothing so as to understand trends of hot-selling products according to colors.

In this case, a row is added to the slip account portion table so that colors of shipped products can be additionally inputted into a account line on the sales slip. An example where colors of products can be additionally inputted by int-type numeral data and char-type character data is explained below.

A new row is added to the slip account portion table by using the above-mentioned embodiment. That is to say, new row names are added as int-type data “C_IntColor” and char-type data “C_CharColor”.

1 of the numerical data is defined as black, 2 is defined as red, 3 is defined as blue, 4 is defined as green, . . . , and a color number and the color of product are additionally inputted into the respective account lines on the sales slip.

Similarly to the case where a row is added to the slip head portion table, since the row name is just added to the slip account portion table, the user uses the writing function of the key task processing means 5 so as to make it possible to write data about the added row into the key task processing database 11.

Since this process adds a new row name into the slip account portion table, DO4_ERP_Wrt3 in the writing functions shown in FIG. 26 is used. Since the arguments which are referred to by the function are the arguments \textcircled{1} to \textcircled{3} and \textcircled{6} to \textcircled{10}, these arguments are set.

The argument \textcircled{1} is data about a row prepared as the sales slip table as well as the name of database in which added colors of shipped products are written and saved, namely, the name of the key task processing database 11. The argument \textcircled{2} is whether or not the contents of the items which do not have to be inputted are checked, namely, 0 means “check” and 1 means “do not check”. As for the argument \textcircled{3}, since data which are originally prepared as the slip head portion table may be used, they are not particularly changed so as to be directly used as the argument. As for the argument \textcircled{6}, the number of account lines in the slip account portion table such as 10 (10 lines) is suitably set. Since as for the argument \textcircled{7}, data which are prepared as the slip account portion table may be used, the data are not particularly changed so as to be directly used as the argument. As for the argument \textcircled{8}, since data about the added row to the slip account portion table are used as the arguments, the numbers of colors and the colors of products are arguments. Further, since the argument \textcircled{9} defines the name of the added row of the argument \textcircled{8}, the type of data and the length of variable, the name of the added row is set as C_IntColor, the data type is set as int type (numerical values related with colors (color numbers) are inputted), and the length of variable is set as 4 bytes (since the int type is integer, the length is 4 bytes. The length occasionally becomes 2 bytes according to programming language). Since two rows are added here, besides C_IntColor, the name of the added row is set as C_CharColor, the data type is set as Char type, and the length of variable is set as 6 bytes (3 two-byte characters). Since the argument \textcircled{10} is a serial number, when a new sales slip is entered as the slip account portion table, the key task processing means 5 sets the serial number as needed, and thus it does not have to be set at first.

When the new writing function “DO4_ERP_Wrt3” is provided to the key task processing means 5 in such a manner, the data about the row added in the above embodiment can be written and saved in the key task processing database 11.

In the case where a new row name is added to both the slip head portion table and the slip account portion table, “DO4_ERP_Wrt1” is used as the function, and all the arguments \textcircled{1} to \textcircled{10} are set similarly to the above embodiment, DO4_ERP_Wrt1 is used as the function when no row name is added, and as its arguments, arguments \textcircled{1} to \textcircled{3}, \textcircled{6}, \textcircled{7} and \textcircled{10} may be set similarly to the above embodiment.

As detailed above, the functions for the adding process are prepared in the key task processing means 5, and two argument portions of the process for the row to be originally used in the key task processing means 5 and of the process for the row added independently by the user are provided as the arguments of the function. As a result, when data are inputted into the row added independently by the user, the data can be written and saved in the key task processing database 11.

Only the writing functions are explained, but when another functions are provided similarly, the processing for the name of the added row can be executed similarly.

On the screen in window format which is actuated at the user terminal (window client) 2, since menu items of a menu bar 31 displayed on the window frame (in this case, it is displayed parallel with the upper end of the window frame) and a menu area 37 set in a predetermined area on the screen are fixed, the user cannot usually add a new menu.

When the processing in the key task processing programs is executed, the user occasionally desires to execute a plurality of works simultaneously. For example, in the case where during inputting and outputting of data by means of the sales management program, the data are desired to be inputted and outputted on another screen or into/from another file, another key task processing program which is different from the sales management program should be actuated.

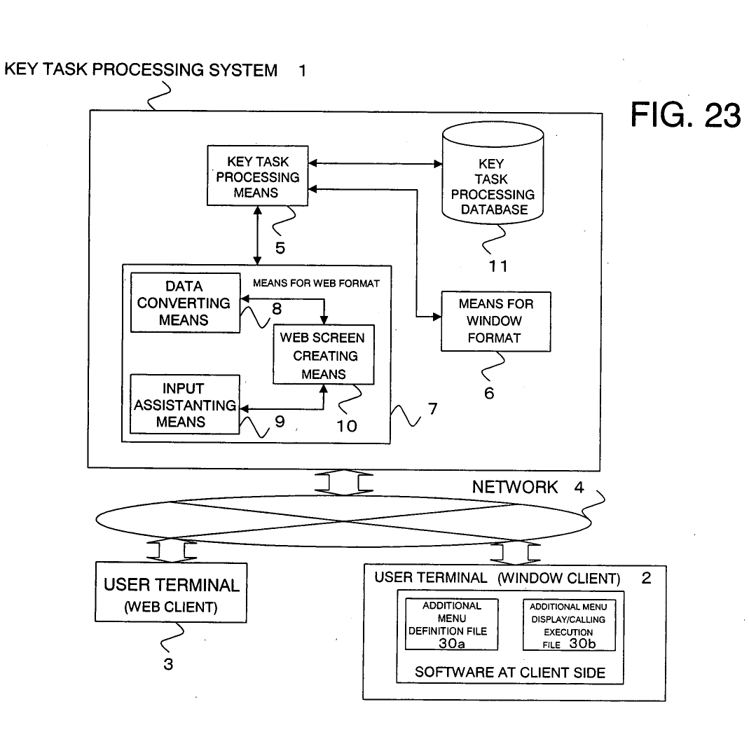

The user terminal (window client) where the key task processing system of the present invention is displayed on the screen in window format preferably has the respective functions in the present invention but also a function for adding a new menu to the menu bar 31 or the menu area 37 disclosed in Japanese Patent Laid-Open Publication No. 2001-166926. The system configuration in this case is explained below. For simplification of the explanation, portions which overlap the above explanation are omitted. FIG. 23 is a system configuration diagram illustrating one example of the system configuration in this case.

The software on the client side which operates the user terminal (window client) 2 has data for adding an additional new function and a program for executing it as well as the above-mentioned display function, input assisting functions and data converting function.

This program has: a additional menu definition file 30a that defines contents of additional menu items; and an additional menu display and calling execution file 30b that reads a menu title 32 or a menu button 35 to be added to the display of the menu items in the menu bar 31 or the menu area 37 on the screen in window format, and additional menu groups to be displayed on a drop-down menu 34 or an additional menu list 36 when the menu title or the menu button 35 is selected from the additional menu definition file 30a so as to display them on the menu bar 31 or the menu area 37 on the screen in window format, and when the additional menu 33 is selected, reads the file so as to execute it.

When, therefore, the additional menu name desired by the user is displayed on the menu bar 31 or the menu area 37, the menu title 32 or the menu button 35 and the additional menu name, which is displayed when the menu title 32 or the menu button 35 is selected, are previously described in the additional menu definition file 30a. As a result, the menu title 32 or the menu button 35 is added and displayed on the menu bar 31 or the menu area 37 by the additional menu display and calling execution file 30b, and when the menu title 32 or the menu button 35 is clicked, the described additional menu groups are displayed.

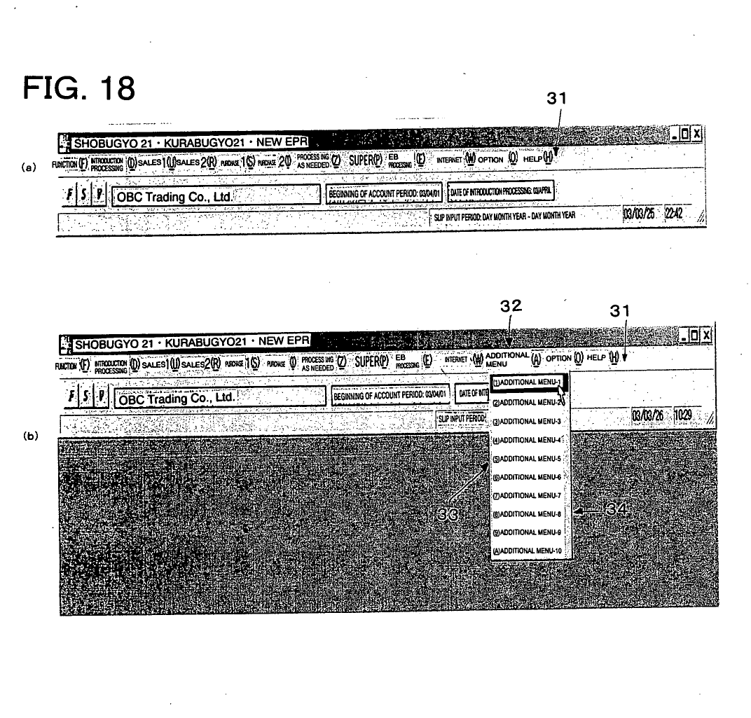

FIG. 18 illustrates a display state of the menu bar 31 which is parallel with the frame on the upper end of the screen in window format. FIG. 18(a) shows the menu bar 31 before the additional menu function is added, and FIG. 18(b) shows the menu bar 31 after the additional menu function is added.

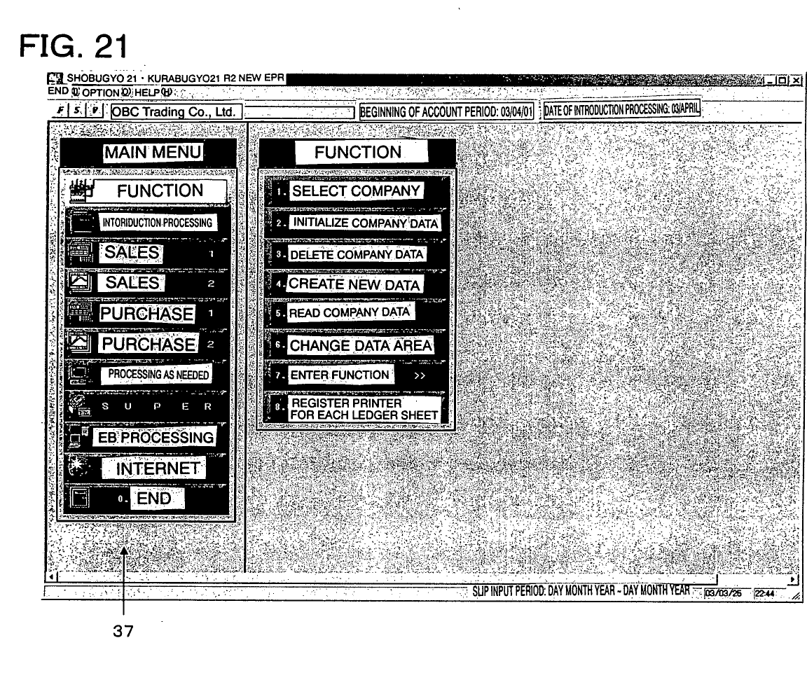

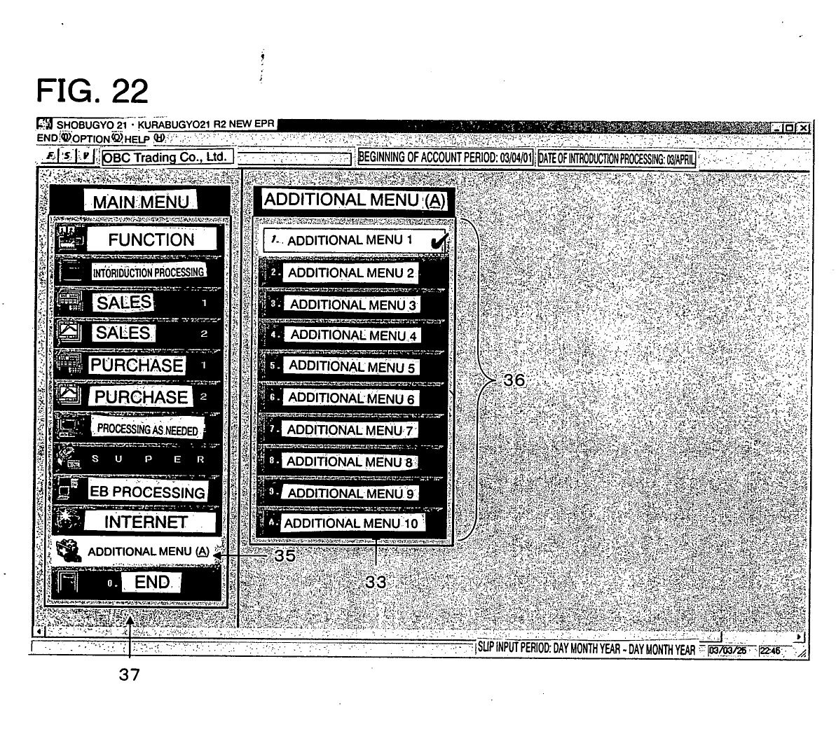

FIGS. 21 and 22 illustrate display states of the menu area 37 of a button format (in this specification, the button includes icons and the like) in a predetermined area (in this case, left portion) of the screen in window format. FIG. 21 illustrates the menu area 37 before the additional menu function is added, and FIG. 22 illustrates the menu area 37 after the additional menu function is added.

When the user selects the additional menu (A) of the menu title 32 or the menu button 35 by clicking it using the pointing device such as a mouse on the screen of the user terminal (window client) 2, the drop-down menu 34 or the additional menu list 36 on which an additional menu 1, an additional menu 2, . . . , an additional menu 10 in the additional menu name are displayed is displayed.

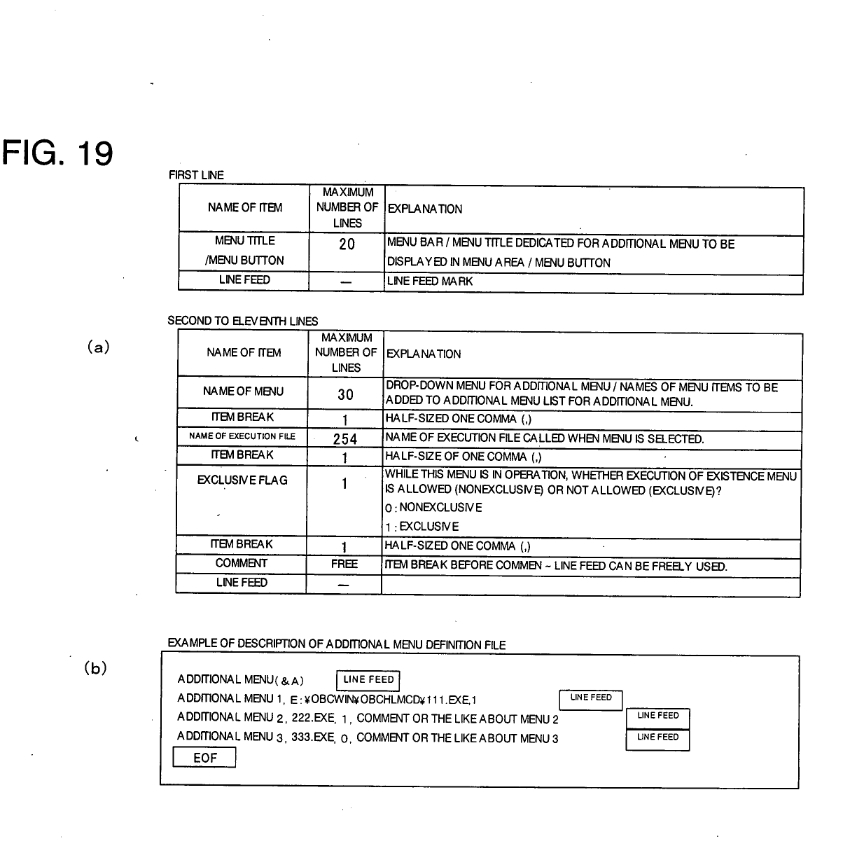

FIG. 19 illustrates the additional menu definition file 30a. FIG. 19(a) illustrates a description format of the additional menu definition file 30a, and FIG. 19(b) illustrates one example of the additional menu definition file 30a.

In the additional menu definition file 30a, the menu title 32 or the menu button 35 is described on the first line, and the additional menu 33 is described on each of the second to the eleventh lines. The description is carried out in a text file format, and the respective lines are broken by linefeed marks. The names of the additional menus, the name of executing file, and an exclusive flag, which sets whether the access from another computer terminal (including a user terminal used by another user) to the one key task processing database 11 is allowed during the access to the file, are separated by predetermined separation marks, for example, a comma (,) so as to be described on the second line and thereafter.

In the case where the execution file is other than the software on the client side, a full pass is added before the executing file. This case is shown in the additional menu of FIG. 19(b). For example, in the case where the program, the executing file or the like in the key task processing system 1 are desired to be called, its full path is described in the additional menu definition file 30a, so that it can be called.

One example of the flow of the process in this case is explained below. When the user sets up the software on the client side compatible with the key task processing system 1 to the user terminal (window client) 2, the additional menu display/calling execution file 30b reads the menu title 32 or the menu button 35 and the additional menu name group from the additional menu definition file 30a in the same folder with the software on the client side at this time.

The menu bar 31 or the menu area 37 into which the new menu title 32 or menu button 35 is added is displayed (in the state of FIG. 18(b)). When the user clicks to select the menu title 32 or the menu button 35 using the pointing device such as the mouse, the drop-down menu 34 or the additional menu list 36 is displayed so that the additional menu group described by the user is displayed in the menu 34 or the list 36.

When the user selects one from the additional menu 33, a check is made whether an exclusive flag is set in the additional menu 33 (execution file), and when exclusive, a check is made whether the additional menu 33 (execution file) is already executed. When it is executed, the calling of it is halted.

On the other hand, when it is not exclusive or is not executed, a location of the execution file of the additional menu 33 is searched by the full path or the like, called and executed.

When the above process is executed, even in the user terminal (window client) 2 to be used in the key task processing system 1 of the present invention, the new additional menu 33 can be displayed on the menu bar 31 or the menu area 37 which is conventionally fixed similarly to the invention disclosed in Japanese Patent Laid-Open Publication No. 2001-66926.

The user reads information about which window format of the screen is selected from local information in the user terminal (window client) 2 so that a determination can be made whether the menu is displayed as the menu bar 31 or as the menu area 37 on the screen in window format. In this case, for example, a technique disclosed in Japanese Patent Laid-Open Publication No. 2001-318750 may be used.

Further, the display of additional menu name on the menu bar 31 or the menu area 37 may be combined with adding and saving of predetermined characters, numbers, symbols and the like in the new table or row added by the user. That is to say, the name of the execution file where the added table and row are used is previously displayed in parallel with the menu name of the software on the client side of the user terminal (window client) 2. When the user selects the execution file which is added by the user from the menu bar 31 or the menu area 37, the execution file which uses the added table and row can be processed. In the case where a plurality of execution files are present, the additional menu names of the execution files added to the additional menu 33 whose number is the same as the number of the execution files are displayed. As a result, the user can use both the prepared execution file and the execution file each of which uses the added table and row from the menu bar 31 or the menu area 37 which is provided in advance to the user terminal (window client) 2.

The functions of the respective means and the databases according to the present invention are just classified logically with respect to their functions, and they may form the same area physically or practically. It goes without saying that a data file may be used instead of a database, and the database includes the data file.

It goes without saying that when the present invention is carried out, a storage medium in which the programs of the software which realize the functions of the embodiment are recorded is provided to the system, and the computer of the system reads and executes the programs stored in the storage medium, thereby realizing the functions.

In this case, the program itself read from the storage medium realizes the functions of the embodiment, and the storage medium in which the programs are stored naturally constitutes the present invention.

As the storage medium for supplying the programs, for example, a magnetic disc, a hard disc, an optical disc, a magneto-optical disc, a magnetic tape, an involatile memory card and the like can be used.

Further, when the programs read by the computer are executed, the functions of the embodiment are realized, and it goes without saying that an operating system which operates on the computer or the like executes some or all actual processing based on instructions of the programs, and the above-mentioned functions of the embodiment are realized by the processings.

Further, it goes without saying that after the programs read from the storage medium are written into a function enhancing board inserted into the computer or an involatile or volatile storage means in an function enhancing means connected to the computer, an arithmetic processing unit or the like in the function enhancing board or the function enhancing unit executes some or all actual processings based on the instructions of the programs, and the functions of the embodiment are realized by the process.

### INDUSTRIAL APPLICABILITY

According to the key task processing system 1 of the present invention, the key task processing system 1 which can be used only in a conventional single system can execute the processing in the conventional window format and also in web format. Since particularly the web format does not depend on OS, the user can easily access the key task processing system 1 even in a place to which the user goes.

Further, in the key task processing system 1 where both the window format and the web format can be used, when a screen in web format is displayed at the user terminal, also the program using JAVA language or the like, which can realize the updating of the relation between the function keys 21 and the processing functions which can be actuated using the function keys 21 and the display on the user terminal, is transmitted. As a result, frequent switching of the screen is eliminated, while the input assisting can be provided to the user.

1. A key task processing program which runs on a computer terminal which executes a key task processing by using one OS and one key task processing database, characterized in that
the key task processing program causes the computer terminal to:
display a screen in window format on a display section of a user's user terminal which executes the key task processing; and
display a screen in web format on the display section of the user's user terminal which executes the key task processing.

2. A key task processing program which runs on a computer terminal which displays a screen in window format and a screen in web format at a user terminal by using one OS and one key task processing database, characterized in that
the key task processing program causes the computer terminal to:
display the screen in window format on a display section of a user's user terminal which executes the key task processing; and
display the screen in web format using a writing format on the display section of the user's user terminal which executes the key task processing,
the user terminal which displays the screen in window format allocates input assisting functions such as “enter” and “halt” which are preset to a plurality of predetermined keys on a keyboard of the user terminal, when the screen in window format is displayed on the display section of the user terminal, displays the names of the input assisting functions, and when a detection is made that the predetermined keys are pressed down or the names of the input assisting functions are selected, executes the input assisting functions.

3. A key task processing program which runs on a computer terminal which displays a screen in window format and a screen in web format at a user terminal using one OS and one key task processing database, characterized in that
the key task processing program causes the computer terminal to:
allocate input assisting functions such as “enter” and “halt” which are preset to a plurality of predetermined keys on a keyboard of the user terminal;
when the screen in window format or web format is displayed on a display section of the user terminal, display names of the input assisting functions; and
when a detection is made that the predetermined key is pressed down or the name of the input assisting function is selected, execute the input assisting function.

4. The key task processing program according to any one of claims 1 to 3, characterized in that the input assisting functions displayed on the screen in window format or the screen in web format allocate input assisting functions related with the screen currently displayed.

5. The key task processing program according to claim 4, characterized in that the input assisting functions displayed on the screen in window format or the screen in web format allocate input assisting functions related with a data input position on the screen currently displayed.

6. The key task processing program according to any one of claims 1 to 3, characterized in that the key task processing program includes one or more of a finance and accounting program, a payroll calculating program, a sales management program, a purchase control program, a stock control program, a tax declaration program, a fixed asset control program, a cost management program, a client management program, a human resource management program, and an electronic banking program.

7. A key task processing system that is capable of transmitting/receiving data to/from a user terminal of a user via a network, comprising:
a key task processing database that stores data for executing key task processings of a company;
a key task processing means which executes the key task processing by using the data in the key task processing database;
a means for window format which transmits/receives the data to be used in the key task processing means via the network to/from the user terminal which accepts input of the key task processing in window format; and
a means for web format which transmits/receives the data to be used in the key task processing means via the network to/from the user terminal which accepts input of the key task processing in web format;
wherein the means for window format and the means for web format execute the processing using the key task processing database on one OS which causes the key task processing system to function.

8. The key task processing system according to claim 7, characterized in that
the user terminal which displays a screen of the key task processing in window format includes:
a data converting function which converts the data in the key task processing means into a data format processable in window format;
an input assisting function used on a screen on which the data are displayed; and
a display function which combines the converted data with the extracted input assisting function to thereby display them on the screen in window format;
wherein the means for web format transmits contents of the screen in web format in document format to the user terminal which accepts the input of the key task processing in web format.

9. The key task processing system according to claim 7 or 8, characterized in that when the data to be used in the key task processing means are transmitted in web format to the user terminal which accepts the input of the key task processing in web format, the means for web format extracts the input assisting function to be used on the screen on which the data are displayed and combines the extracted input assisting function with the data to thereby transmit contents of the screen in web format.

10. The key task processing system according to claim 8, characterized in that the means for web format comprises:
a data converting means which converts the data in the key task processing means into a data format processable in web format;
an input assisting means which extracts the input assisting functions to be used on the screen on which the data are displayed; and
a web screen creating means which combines the data converted by the data converting means with the extracted input assisting functions to thereby create the screen in web format.

11. The key task processing system according to claim 8, characterized in that the input assisting functions are related with function keys on a keyboard of the user terminal, and when the screen is changed or a cursor position is changed on the screen, the key task processing system changes a corresponding relationship between the input assisting functions and the function keys and changes display of the names of the input assisting functions on the screen according to the change of the corresponding relationship.

12. The key task processing system according to claim 8, characterized in that the input assisting function receives pressing-down of the function key, or receives selection of the name of the input assisting function on the screen using a pointing device, and executes the related input assisting function at the user terminal.

13. The key task processing system according to claim 7, characterized in that the key task processing means,
when a new table or row is added, adds any one of predetermined character, number and symbol to a head of the table name or the row name and stores it in the key task processing database, and
when data of the key task processing database are saved, saves a table or a row predetermined by the key task processing means and a table or a row having the predetermined character, number or symbol at the head of the table name or the row name.

14. The key task processing system according to claim 7, characterized in that when the key task processing means stores the row newly added by a user in the key task processing database, a function which is set by accepting the setting of a row name, a data type and a data length of the added row as arguments of the function which is previously owned by the key task processing means and which executes a writing/saving processing stores the data of the newly added row in the key task processing database.

15. The key task processing system according to claim 7, characterized in that the user terminal which accepts the input of the key task processing in window format includes:
an additional menu definition file which defines contents of additional menu items to be displayed on a menu bar provided in a frame of the screen in window format or on a menu area provided in the screen in window format; and
an additional menu display/calling execution file which reads a menu title or a menu button, which is added to the menu bar on the display of the menu items in the menu area, and an additional menu group, which is displayed on a drop-down menu or an additional menu list when the menu title or the menu button is selected, from the additional menu definition file, displays them on the menu bar or on the screen in window format, and reads and executes a related execution file, with which the additional menu is related, when the additional menu is selected.

16. The key task processing system according to claim 7, characterized in that the key task processing includes at least one or more of a finance and accounting processing, a payroll calculation processing, a sales management processing, a purchase control processing, a stock control processing, a tax declaration processing, a fixed asset control processing, a cost management processing, a client management processing, a human resource management processing, and an electronic banking.
